(19) United States
(12) Patent Application Publication
(10) Pub. No.: US 2023/0090821 A1
(43) Pub. Date: Mar. 23, 2023

(54) SILICONE-BASED COMPOSITIONS CONTAINING CARBON NANOSTRUCTURES FOR CONDUCTIVE AND EMI SHIELDING APPLICATIONS

(71) Applicant: Cabot Corporation, Boston, MA (US)

(72) Inventors: Xiaofeng Zhang, Shrewsbury, MA (US); Sean Sullivan, Lynn, MA (US); Limeng Chen, Arlington, MA (US); Jeffrey Gamble, North Andover, MA (US); Angelica M. Sanchez Garcia, Somerville, MA (US); Agathagelos Kyrlidis, Cambridge, MA (US); Yakov E. Kutsovsky, Arlington, MA (US)

(21) Appl. No.: 17/801,362

(22) PCT Filed: Feb. 24, 2021
(86) PCT No.: PCT/US2021/019407

§ 371 Date: Aug. 22, 2022

Related U.S. Application Data
(60) Provisional application No. 62/981,081, filed on Feb. 25, 2020.
(60) Provisional application No. 63/005,692, filed on Apr. 6, 2020.

(51) Int. Cl. C08K 3/04

(52) U.S. Cl. CPC C08K 3/041; C08K 2201/001

(57) ABSTRACT

Carbon nanostructures are used to prepare curable silicone-based compositions that can be used to manufacture various molded parts for EMI shielding applications. In one illustration, a cured material includes carbon nanostructures, fragments of carbon nanostructures, fractured carbon nanotubes, elongated carbon strands, and/or dispersed carbon nanostructures dispersed in a silicone component.

### BACKGROUND OF THE INVENTION

Characterized by many attractive properties, silicones have found applications in fields as diverse as food and beverage, automotive, aerospace, communication, pharmaceuticals, pulp and paper, coatings, paints, textiles, electronics and other industries. They are used to make rigid or flexible articles, as processing aids, in adhesives or sealants and so forth. An overview of their widespread uses is presented, for example, by M. Andriot, et al., in Silicones in Industrial Applications, Inorganic Polymers, Gleria, R. D. J. M., Ed. Nova Science Publishers: 2007; pp 61-161.

One emerging application for silicones relates to products such as mats, sheets, pads, gaskets, and other articles designed to shield against electromagnetic interference (EMI) or electrostatic discharge (ESD) occurrences. EMI can be generated by communication systems, radio, television, electronic devices or circuits within such devices. Problems related to EMI are exacerbated by the continued goals of achieving circuit size reductions and higher operational frequencies. Electromagnetic radiation can interfere with circuits or systems in various devices, between equipment, and/or disrupt their operation. Under some circumstances, an electrostatic spark can initiate a combustion process, posing serious dangers.

Some existing EMI applications of silicones involve the use of electrically conductive metals, alloys, metal/non-metal composites, and carbon additives, such as, for instance, carbon black, graphite, graphene-based type materials and carbon nanotubes.

U.S. Pat. No. 8,715,533B2, for example, discloses a dielectric raw material having carbons dispersed in a silicone rubber base material containing a silicone rubber as a main material. The carbons are unevenly distributed in the silicone rubber base material or in a manner in which at least a portion of the carbons contact each other. According to this reference, the dielectric raw material can contain 150 to 300 parts by weight of the carbons per 100 parts by weight of the silicone rubber. The dielectric raw material can be formed by crosslinking and molding a mixture of the silicone rubber in its non-crosslinked state, a non-crosslinked organic polymer and the carbons. At least two kinds of the carbons having different shapes and selected from spherical carbon, flat carbon, carbon fiber with an aspect ratio of not more than 11, carbon nanotube and conductive carbon can be combined and blended to form the dielectric raw material.

According to U.S. Pat. No. 7,479,516B2, nanocomposites containing a functionalized, solubilized nanomaterial such as a functionalized and solubilized single-walled carbon nanotube, multi-walled carbon nanotube, carbon nanoparticle, carbon nanosheet, carbon nanofiber, carbon nanorope, carbon nanoribbon, carbon nanofibril, carbon nanoneedle, carbon nanohom, carbon nanocone, carbon nanoscroll, carbon nanodot, or a combination thereof are used for electrical, thermal and mechanical applications.

EP3546524A1 discloses carbon nanotubes that are employed as a conductive filler to impart conductivity to insulating silicone rubber.

According to US20100308279A1, conductive silicone elastomers are prepared using carbon nanotubes in individual form or in the form of aggregates having a macromorphology resembling the shape of a cotton candy, bird nest, combed yarn or open net. Preferred multiwalled carbon nanotubes have diameters no greater than 1 micron and preferred single walled carbon nanotubes have diameters less than 5 nm.

Conducting polymer composites containing nanotubes also are described in KR1753845B1.

As presented in U.S. Pat. No. 9,181,278B2, a method of preparing a carbon nanotube composite with metal particles on a surface thereof includes: introducing an acylhalide group to the surface, causing a reaction of the acylhalide group with an amine group of a polysiloxane to bond the polysiloxane to the surface by the amide groups, and introducing metal particles to other functional groups of the polysiloxane to bond the metal particles to the surface of the carbon nanotube composite.

A multi-walled carbon nanotube-silicone masterbatch, under the commercial name of ANTIS™-SIL 102 conductive CNT was designed as an additive for silicone-based static dissipative and electrically conductive applications.

US20180177081A1 describes EMI shielding composites prepared using carbon nanostructure fillers in which carbon nanotubes (CNTs) that are crosslinked are encapsulated in a polymeric encapsulation material. To obtain the EMI shielding composites, the fillers are first treated to remove at least a portion of the polymeric encapsulation material, then mixed with a curable matrix material.

A composite composition comprising a crosslinked silicone foam having polydimethylsiloxane segments, and electromagnetically responsive particles, such as crosslinked multi-wall carbon nanotube networks, retained in the crosslinked silicone foam, is described in US20190352543A1.

Sensors based on carbon nanostructures-polydimethylsiloxane nanocomposites are described by M. F. Arif in Strong linear-piezoresistive-response of carbon nanostructures reinforced hyperelastic polymer nanocomposites, Composites Part A 113 (2018), pp. 141-149.

Various current materials and desirable attributes for EMI shielding applications are described by Liying Zhang, Shuguang Bi and Ming Liu in the chapter Lightweight Electromagnetic Interference Shielding Materials and Their Mechanisms, submitted on Jul. 23, 2018, reviewed on Oct. 26, 2018 and published on Dec. 2, 2018 in IntechOpen book with the title Electromagnetic Materials and Devices, Man-Gui Han, editor.

### SUMMARY OF THE INVENTION

With the continued goals toward smaller circuitry and higher operational frequencies, a need continues to exist for improving conductivity or EMI shielding. A need also exists for enhancing attributes characterizing silicone-based compositions and articles. As used herein, silicone-based polymers include both polysiloxanes and cured hybrid polymer systems that include siloxane (—Si—O—)ₙ segments. Thus, the uncured silicone-based polymers, including those in the CNS masterbatches described below, may include hybrid polymers that do not yet include siloxane segments, as these cure via formation of siloxanes.

In some of its aspects, the invention relates to silicone-based compositions that contain silicone based polymers and carbon nanostructures (CNSs). In some embodiments, compositions or articles contain carbon nanostructures, fragments of carbon nanostructures, fractured carbon nanotubes, elongated CNS strands, and/or dispersed CNSs distributed in a silicone-based component.

As used herein, the term “carbon nanostructure” or “CNS” refers to a plurality of carbon nanotubes (CNTs), multiwall (also known as multi-walled) carbon nanotubes (MWCNTs), in many cases, that can exist as a polymeric structure by being interdigitated, branched, crosslinked, and/or sharing common walls with one another. Thus, CNSs can be considered to have CNTs, such as, for instance, MWCNTs, as a base monomer unit of their polymeric structure. Typically, CNSs are grown on a substrate (e.g., a fiber material) under CNS growth conditions. In such cases, at least a portion of the CNTs in the CNSs can be aligned substantially parallel to one another, much like the parallel CNT alignment seen in conventional carbon nanotube forests.

Typically, CNSs are grown on a substrate (e.g., a fiber material) under CNS growth conditions. They can be separated from the substrate to form CNS flakes. Some of the embodiments described herein use coated or encapsulated CNSs. CNS flakes, powders, dispersions or other forms in which CNSs can be initially provided also can be employed.

In specific examples, the CNS is provided at a loading of 0.01 to 15 weight % of the formulation, for example 0.1 to 10 wt % or 3 to 5 wt %. In many cases, a loading of less than or equal to 5 wt % can result in a volume resistivity of the silicone-containing composition that is lower than 2 ohm·cm. It was further discovered that relatively low amounts of CNSs (e.g., loadings of less than 1 wt %, less than 0.5 wt %, less than 0.1 wt % or less than 0.05 wt %, for example, from 0.01% to 1 wt %) can be sufficient to reach the electrical percolation threshold for the silicone-based polymer—CNS system. It is believed that this effect is due, at least in part, to the formation of fragments that sustain branching, allowing better connectivity between them and creating enhanced conductivity connections.

In some cases, CNSs can be employed in conjunction with additional additives such as carbon black, fumed silica, nickel coated graphite, and/or metal flakes. Other implementations may employ combinations of CNS with silica, nickel coated graphite, metal flakes, particles, wires, nanowires, and fibers, carbon fibers, CNTs, graphenes, graphite, and other additives commonly used in silicone based compositions. Other additives and mixtures of additives may be employed as well.

Thoroughly dispersing the CNSs in the uncured precursor to the silicone-based polymer and forming a well or fully dispersed composition can be an important aspect of the invention and some implementations described herein relate to the mode in which CNSs (alone or in combination with one or more additional additives) are combined with the precursor to the silicone-based polymer. Encapsulated or coated CNSs may be employed without the necessity of removing the binder or coating. Some embodiments rely on a masterbatch (MB) process to prepare a masterbatch concentrate in a liquid or solid media. The masterbatch is then diluted to prepare a system having a desired CNS loading. The concentrate can be diluted by the same media used in the masterbatch preparation, or a different media. The media can be a resin, a resin mixture, a polymer, a solvent, or a solvent mixture, or a solution, or a combination of them. Thorough dispersion of CNSs can result in desired electrical properties even at very low loadings. It is believed that this effect is due, at least in part, to the formation of fragments that sustain branching, allowing better connectivity between them and creating enhanced conductivity connections.

The precursor to the silicone-based polymer can be cured in a single-component or a two-component system using peroxide or platinum-catalyzed addition curing agent. Condensation curing, with the hydroxyl groups of the polymer reacting with a siloxane curing agent, also can be employed, as can moisture-based curing or radiation. In some cases, the silicone-based compound is cured by an amino-containing curing agent. Other curing techniques and agents can be used as known in the art or as developed in the future. Alternatively or in addition, following curing, the silicone-based rubber or elastomer can be post-cured, for example, by heating to a temperature at which additional siloxane bonds can form.

Many of the embodiments described herein relate to CNS-containing silicone-based systems, also referred to herein as “composites,” that can be molded, or extruded to form a shape or profile. Among these, of particular interest are systems characterized by good mechanical properties (e.g., tensile strength, hardness) and/or electrical conductivity, and/or thermal conductivity.

CNSs may present various advantages over ordinary CNTs, possibly due to the CNS unique structure. Also, in contrast to CNTs, CNSs can be provided in forms (powders, for instance) that are easy and safe to handle on the industrial scale.

Compositions described herein can be used in preparing various rigid or flexible articles, molded parts, elastomers, coatings, potting or gap filling formulations, gasketing, films or membranes, field gratings, adhesives, sealants, electrodes, for ESD and/or EMI shielding applications, for wire and cable applications, and so forth. Materials according to embodiments of the invention can often be prepared easily, at attractive cost, can be molded to fabricate parts of reduced sizes and/or weight, present good mechanical properties such as tensile strength, tear strength, etc., and good EMI shielding performance, e.g., in the 1 kHz-300 GHz frequency range.

In one embodiment, a cured polymer composite, comprises a cured polymer comprising a cured siloxane polymer or a cured silyl-terminated hybrid polymer, and at least one CNS-derived material dispersed in the cured polymer and selected from the group consisting of: carbon nanostructures, fragments of carbon nanostructures, fractured carbon nanotubes, elongated CNS strands, dispersed CNSs, and any combination thereof. The carbon nanostructures or fragments of carbon nanostructures include a plurality of multiwall carbon nanotubes that are crosslinked in a polymeric structure by being branched, interdigitated, entangled and/or sharing common walls. The fractured carbon nanotubes are derived from the carbon nanostructures and are branched and share common walls with one another. Elongated CNS strands are derived from the carbon nanostructures and include CNTs that have been displaced linearly with respect to one another. Dispersed CNS comprise exfoliated fractured CNTs that do not share common walls with one another.

The cured polymer composite may include 0.01 to 15 wt %, for example, 1 to 10 wt %, 3 to 5 wt %, less than 10 wt %, less than 5 wt %, less than 1 wt %, less than 0.5 wt %, less than 0.1 wt %, less than 0.05 wt %, or from 0.01% to 1 wt % of CNS-derived material.

The siloxane polymer may include Me₃SiO (SiMe₂O)ₙ Me, wherein n is at least 2, wherein at least one methyl group is optionally substituted with a group selected from R′ and —(O—SiR′R″)ₙ—, wherein R′ and R″ are independently linear or branched alkyl, linear or branched haloalkyl, aryl, haloaryl, alkoxy, aralkyl, sila-cycloalkyl, alkenyl, acrylate, methacrylate, amino, imino, hydroxy, epoxy, ester, alkyloxy, isocyanate, phenolic, polyurethane oligomeric, polyamide oligomeric, polyester oligomeric, polyether oligomeric, polyol, carboxypropyl, or halo. The silyl-terminated hybrid polymer may include an alkoxysilane terminated polyacrylate, polyurethane, epoxy, or polyether.

The cured polymer composite may have one or more of a tensile strength greater than 0.5 MPa or from 0.5 MPa to 10 MPa, an elongation at break of 40% to 300%, and a volume resistivity of less than 10⁵ ohm·cm. The cured polymer may be crosslinked. The composition may be a cured polymer composition having a shielding efficiency equivalent to at least 35 dB for a 2 mm thick sample at 1.5 GHz. The carbon nanostructures may be coated or in a mixture with a binder.

The cured polymer composite may further include at least one additive selected from the group consisting of fumed silica, precipitated silica, semiconducting oxides, nickel coated graphite, metals, metal alloys, carbon fibers, CNTs, graphenes, graphite, carbon black, clay, metal carbides, metal nitrides, metal phosphates, metal sulfates, metal carbonates, metal halides, metal hydroxides, glass, and organic fibers.

An article for electromagnetic interference shielding may include the cured polymer composite of any of the above embodiments.

In another aspect, a method for preparing a polymer composite for electromagnetic interference shielding comprises combining carbon nanostructures with an uncured polymer comprising a curable and moldable polymer selected from a polysiloxane or a silyl-terminated hybrid polymer to form a mixture and disperse the carbon nanostructures in the uncured polymer and generate CNS-derived material selected from fractured carbon nanotubes, elongated CNS strands, dispersed CNS, and any combination thereof. The carbon nanostructures or fragments of carbon nanostructures include a plurality of multiwall carbon nanotubes that are crosslinked in a polymeric structure by being branched, interdigitated, entangled and/or sharing common walls. The fractured carbon nanotubes are derived from the carbon nanostructures and are branched and share common walls with one another. Elongated CNS strands are derived from the carbon nanostructures and include CNTs that have been displaced linearly with respect to one another. Dispersed CNS comprise exfoliated fractured CNTs that do not share common walls with one another.

Combining may include dispersing the carbon nanostructures until observation of a microscopic image of the mixture having 1000 microns×1400 microns or equivalent area reveals no more than one fragment of a carbon nanostructure having a bundle width greater than 50 microns, wherein the mixture is prepared for observation by diluting the mixture to a CNS-derived material loading of about 0.1% with additional uncured polymer and pressing a drop-sized aliquot between two glass microscope slides.

The polysiloxane may include Me₃SiO (SiMe₂O)ₙ Me, wherein n is at least 2, wherein at least one methyl group is optionally substituted with a group selected from R′ and —(O—SiR′R″)ₙ—, wherein R′ and R″ are independently linear or branched alkyl, linear or branched haloalkyl, aryl, haloaryl, alkoxy, aralkyl, sila-cycloalkyl, alkenyl, acrylate, methacrylate, amino, imino, hydroxy, epoxy, ester, alkyloxy, isocyanate, phenolic, polyurethane oligomeric, polyamide oligomeric, polyester oligomeric, polyether oligomeric, polyol, carboxypropyl, or halo. The silyl-terminated hybrid polymer may include an alkoxysilane terminated polyacrylate, polyurethane, epoxy, or polyether.

Combining may include mixing the carbon nanostructures with a media selected from an oil, a reactive diluent, a non-reactive diluent, an aqueous solvent, a non-aqueous solvent, or a plasticizer to form a masterbatch, and mixing the masterbatch with the uncured polymer to form the mixture. The method may further include combining the mixture with a letdown polymer selected from a polysiloxane or silyl-terminated hybrid polymer. The polysiloxane may be a component of a one-component curable silicone-based polymer system or a two-component curable silicone-based polymer system. The carbon nanostructures may be provided in an amount of 0.01 to 15 wt %, 1 to 10 wt %, 3 to 5 wt %, less than 10 wt %, less than 5 wt %, less than 1 wt %, less than 0.5 wt %, less than 0.1 wt %, less than 0.05 wt %, or from 0.01% to 1 wt %. The carbon nanostructures may be coated or in a mixture with a binder.

The weight of the binder relative to the weight of the coated carbon nanostructures may be within the range of from about 0.1% to about 10%. The method may further include adding at least one additive to the mixture, the additive selected from the group consisting of fumed silica, precipitated silica, semiconducting oxides, nickel coated graphite, metals, metal alloys, carbon fibers, CNTs, graphenes, graphite, carbon black, clay, metal carbides, metal nitrides, metal phosphates, metal sulfates, metal carbonates, metal halides, metal hydroxides, glass, and organic fibers. The method may further include curing the mixture or allowing it to cure. The mixture may be cured in the presence of one or more of a catalyst, heat, cross-linker, moisture, microwave radiation, blue LEDs, ultraviolet light, electron beam radiation, and a photoinitiator. A polymer composite may be prepared according to any of the methods described above. Observation of an optical microscopic image of the polymer composite having 1000 micron×1400 micron or equivalent area may reveal no more than one fragment of a carbon nanostructure having a bundle width greater than 50 microns, wherein the polymer composite is prepared for observation by diluting the polymer composite to a CNS loading of 0.1% with additional uncured polymer and pressing a drop-sized aliquot between two glass microscope slides.

In another aspect, a curable polymer composition may include an uncured polymer comprising a curable and moldable polymer selected from a polysiloxane or a silyl-terminated hybrid polymer and CNS-derived material selected from fractured carbon nanotubes, elongated CNS strands, dispersed CNS, and any combination thereof. The carbon nanostructures or fragments of carbon nanostructures include a plurality of multiwall carbon nanotubes that are crosslinked in a polymeric structure by being branched, interdigitated, entangled and/or sharing common walls. The fractured carbon nanotubes are derived from the carbon nanostructures and are branched and share common walls with one another. Elongated CNS strands are derived from the carbon nanostructures and include CNTs that have been displaced linearly with respect to one another. Dispersed CNS comprise exfoliated fractured CNTs that do not share common walls with one another.

When the curable polymer composition is prepared for observation in an optical microscope by diluting the composition to a CNS-derived material loading of about 0.1% with additional uncured polymer and pressing a drop-sized aliquot between two glass microscope slides to create a specimen, a microscopic image showing an area of the specimen of 1000 microns×1400 microns or equivalent area may contain no more than one fragment of a carbon nanostructure having a bundle width greater than 50 microns.

The polysiloxane may include Me₃SiO (SiMe₂O)ₙ Me, wherein n is at least 2, wherein at least one methyl group is optionally substituted with a group selected from R′ and —(O—SiR′R″)ₙ—, wherein R′ and R″ are independently linear or branched alkyl, linear or branched haloalkyl, aryl, haloaryl, alkoxy, aralkyl, sila-cycloalkyl, alkenyl, acrylate, methacrylate, amino, imino, hydroxy, epoxy, ester, alkyloxy, isocyanate, phenolic, polyurethane oligomeric, polyamide oligomeric, polyester oligomeric, polyether oligomeric, polyol, carboxypropyl, or halo. The silyl-terminated hybrid polymer may include an alkoxysilane terminated polyacrylate, polyurethane, epoxy, or polyether. The curable polymer composition may further include an oil, a reactive diluent, a non-reactive diluent, an aqueous solvent, a non-aqueous solvent, or a plasticizer. The polysiloxane may be a component of a one-component curable silicone-based polymer system or a two-component curable silicone-based polymer system. The CNS-derived material may be present in an amount of 0.01 to 15 wt %, for example, 1 to 10 wt %, 3 to 5 wt %, less than 10 wt %, less than 5 wt %, less than 1 wt %, less than 0.5 wt %, less than 0.1 wt %, less than 0.05 wt %, or from 0.01% to 1 wt %. The CNS-derived material may further include a binder. The weight of the binder relative to the weight of the CNS-derived material may be within the range of from about 0.1% to about 10%. The curable polymer composition may further include at least one additive selected from the group of fumed silica, precipitated silica, semiconducting oxides, nickel coated graphite, metals, metal alloys, carbon fibers, CNTs, graphenes, graphite, carbon black, clay, metal carbides, metal nitrides, metal phosphates, metal sulfates, metal carbonates, metal halides, metal hydroxides, glass, and organic fibers.

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A and 1B are diagrams illustrating differences between a Y-shaped MWCNT, not in or derived from a carbon nanostructure (FIG. 2A), and a branched MWCNT (FIG. 2B) in a carbon nanostructure.

FIGS. 2A and 2B are TEM images showing features characterizing multiwall carbon nanotubes found in carbon nanostructures.

FIG. 3A is an illustrative depiction of a carbon nanostructure flake material after isolation of the carbon nanostructure from a growth substrate;

FIG. 3B is a SEM image of an illustrative carbon nanostructure obtained as a flake material;

FIG. 4 is a light micrograph of uncured silicone-based resin filled with dispersed CNSs;

FIG. 5 is a graph illustrating percolation curves for CNS in LSR and HTV polysiloxane formulations.

FIGS. 6A and 6B are graphs illustrating the EMI shielding power of various filled polysiloxane formulations with respect to frequency.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The invention generally relates to conductive polymeric systems in which the polymeric component includes one or more silicone-based polymers and conductivity is provided by at least one carbon additive. Many of the embodiments described herein relate to systems that are moldable. Among these, of particular interest are systems characterized by good mechanical properties such as tensile strength or hardness (properties that often are associated with the polymer utilized) and/or electrical conductivity (imparted by the carbon additive). Materials described herein also can have attributes desirable in EMI shielding applications such as, for instance, lightness, corrosion resistance, ease of manufacture, flexibility and attractive shielding efficiencies based, for instance, on reflection and/or absorption mechanisms.

The composition is prepared using carbon nanostructures (CNSs, singular CNS), a term that refers herein to a plurality of carbon nanotubes (CNTs) that that are crosslinked in a polymeric structure by being branched, e.g., in a dendritic fashion, interdigitated, entangled and/or sharing common walls with one another. Operations conducted to prepare the compositions described herein can generate CNS fragments, fractured CNTs, and/or elongated CNS strands. Fragments of CNSs are derived from CNSs and, like the larger CNS, include a plurality of CNTs that are crosslinked in a polymeric structure by being branched, interdigitated, entangled and/or sharing common walls. Fractured CNTs are derived from CNSs and are branched and share common walls with one another. Elongated CNS strands are structures derived from CNSs (including from fragments of CNSs and fractured CNTs) in which the component CNTs have been displaced linearly with respect to each other. Preferably, the operations conducted to prepare the compositions described herein generate dispersed CNSs that are more completely exfoliated, and they may retain junctions and intersections between the component CNTs that were created during production of the CNSs.

Highly entangled CNSs are macroscopic in size and can be considered to have a carbon nanotube (CNT) as a base monomer unit of its polymeric structure. For many CNTs in the CNS structure, at least a portion of a CNT sidewall is shared with another CNT. While it is generally understood that every carbon nanotube in the CNS need not necessarily be branched, crosslinked, or share common walls with other CNTs, at least a portion of the CNTs in the carbon nanostructure can be interdigitated with one another and/or with branched, crosslinked, or common-wall-sharing carbon nanotubes in the remainder of the carbon nanostructure.

As known in the art, carbon nanotubes (CNT or CNTs plural) are carbonaceous materials that include at least one sheet of sp²-hybridized carbon atoms bonded to each other to form a honey-comb lattice that forms a cylindrical or tubular structure. The carbon nanotubes can be single-walled carbon nanotubes (SWCNTs) or multi-walled carbon nanotubes (MWCNTs). SWCNTs can be thought of as an allotrope of sp²-hybridized carbon similar to fullerenes. The structure is a cylindrical tube including six-membered carbon rings. Analogous MWCNTs, on the other hand, have several tubes in concentric cylinders. The number of these concentric walls may vary, e.g., from 2 to 25 or more. Typically, the diameter of MWNTs may be 10 nm or more, in comparison to 0.7 to 2.0 nm for typical SWNTs.

In many of the CNSs used in this invention, the CNTs are MWCNTs, having, for instance, at least two coaxial carbon nanotubes. The number of walls present, as determined, for example, by transmission electron microscopy (TEM), at a magnification sufficient for analyzing the number of wall in a particular case, can be within the range of from 2 to 30 or so, for example: 4 to 30; 6 to 30; 8 to 30; 10 to 30; 12 to 30; 14 to 30; 16 to 30; 18 to 30; 20 to 30; 22 to 30; 24 to 30; 26 to 30; 28 to 30; or 2 to 28; 4 to 28; 6 to 28; 8 to 28; 10 to 28; 12 to 28; 14 to 28; 16 to 28; 18 to 28; 20 to 28; 22 to 28; 24 to 28; 26 to 28; or 2 to 26; 4 to 26; 6 to 26; 8 to 26; 10 to 26; 12 to 26; 14 to 26; 16 to 26; 18 to 26; 20 to 26; 22 to 26; 24 to 26; or 2 to 24; 4 to 24; 6 to 24; 8 to 24; 10 to 24; 12 to 24; 14 to 24; 16 to 24; 18 to 24; 20 to 24; 22 to 24; or 2 to 22; 4 to 22; 6 to 22; 8 to 22; 10 to 22; 12 to 22; 14 to 22; 16 to 22; 18 to 22; 20 to 22; or 2 to 20; 4 to 20; 6 to 20; 8 to 20; 10 to 20; 12 to 20; 14 to 20; 16 to 20; 18 to 20; or 2 to 18; 4 to 18; 6 to 18; 8 to 18; 10 to 18; 12 to 18; 14 to 18; 16 to 18; or 2 to 16; 4 to 16; 6 to 16; 8 to 16; 10 to 16; 12 to 16; 14 to 16; or 2 to 14; 4 to 14; 6 to 14; 8 to 14; 10 to 14; 12 to 14; or 2 to 12; 4 to 12; 6 to 12; 8 to 12; 10 to 12; or 2 to 10; 4 to 10; 6 to 10; 8 to 10; or 2 to 8; 4 to 8; 6 to 8; or 2 to 6; 4 to 6; or 2 to 4.

Since a CNS is a polymeric, highly branched and crosslinked network of CNTs, at least some of the chemistry observed with individualized CNTs may also be carried out on the CNS. In addition, some of the attractive properties often associated with using CNTs also are displayed in materials that incorporate CNSs. These include, for example, electrical conductivity, attractive physical properties including maintaining or enabling good tensile strength when integrated into a silicone-based composition, thermal stability (sometimes comparable to that of diamond crystals or in-plane graphite sheets) and/or chemical stability, to name a few.

However, as used herein, the term “CNS” is not a synonym for individualized, un-entangled structures such as “monomeric” fullerenes (the term “fullerene” broadly referring to an allotrope of carbon in the form of a hollow sphere, ellipsoid, tube, e.g., a carbon nanotube, and other shapes). In fact, many embodiments of the invention highlight differences and advantages observed or anticipated with the use of CNSs as opposed to the use of their CNTs building blocks. Without wishing to be held to a particular interpretation, it is believed that the combination of branching, crosslinking, and wall sharing among the carbon nanotubes in a CNS reduces or minimizes the van der Waals forces that are often problematic when using individual carbon nanotubes in a similar manner, especially when it is desirable to prevent agglomeration.

In addition, or alternatively to performance attributes, CNTs that are part of or are derived from a CNS can be characterized by a number of features, at least some of which can be relied upon to distinguish them from other nanomaterials, such as, for instance, ordinary CNTs (namely CNTs that are not derived from CNSs and can be provided as individualized, pristine or fresh CNTs).

In many cases, a CNT present in or derived from a CNS has a typical diameter of 100 nanometers (nm) or less, such as, for example, within the range of from about 5 to about 100 nm, e.g., within the range of from about 10 to about 75, from about 10 to about 50, from about 10 to about 30, from about 10 to about 20 nm.

In specific embodiments, at least one of the CNTs has a length that is equal to or greater than 2 microns, as determined by SEM. For example, at least one of the CNTs will have a length within a range of from 2 to 2.25 microns; from 2 to 2.5 microns; from 2 to 2.75 microns; from 2 to 3.0 microns; from 2 to 3.5 microns; from 2 to 4.0 microns; or from 2.25 to 2.5 microns; from 2.25 to 2.75 microns; from 2.25 to 3 microns; from 2.25 to 3.5 microns; from 2.25 to 4 microns; or from 2.5 to 2.75 microns; from 2.5 to 3 microns; from 2.5 to 3.5 microns; from 2.5 to 4 microns; or from 3 to 3.5 microns; from 3 to 4 microns; of from 3.5 to 4 microns or higher. In some embodiments, more than one, e.g., a portion such as a fraction of at least about 0.1%, at least about 1%, at least about 10%, at least about 15%, at least about 20%, at least about 25%, at least about 30%, at least about 35%, at least about 40, at least about 45%, at least about 50% or even more than one half, of the CNTs, as determined by SEM, can have a length greater than 2 microns, e.g., within the ranges specified above.

The morphology of CNTs present in a CNS, in a fragment of a CNS or in a fractured CNT derived from a CNS will often be characterized by a high aspect ratio, with lengths typically more than 100 times the diameter, and in certain cases much higher. For instance, in a CNS (or CNS fragment), the length to diameter aspect ratio of CNTs can be within a range of from about 200 to about 1000, such as, for instance, from 200 to 300; from 200 to 400; from 200 to 500; from 200 to 600; from 200 to 700; from 200 to 800; from 200 to 900; or from 300 to 400; from 300 to 500; from 300 to 600; from 300 to 700; from 300 to 800; from 300 to 900; from 300 to 1000; or from 400 to 500; from 400 to 600; from 400 to 700; from 400 to 800; from 400 to 900; from 400 to 1000; or from 500 to 600; from 500 to 700; from 500 to 800; from 500 to 900; from 500 to 1000; or from 600 to 700; from 600 to 800; from 600 to 900; from 600 to 1000; from 700 to 800; from 700 to 900; from 700 to 1000; or from 800 to 900; from 800 to 1000; or from 900 to 1000.

It has been found that in CNSs, as well as in structures derived from CNSs (e.g., in fragments of CNSs or in fractured CNTs or elongated CNS strands or dispersed CNSs) at least one of the CNTs is characterized by a certain “branch density”. As used herein, the term “branch” refers to a feature in which a single carbon nanotube diverges into multiple (two or more), connected multiwall carbon nanotubes. One embodiment has a branch density according to which, along a two-micrometer length of the carbon nanostructure, there are at least two branches, as determined by SEM. Three or more branches also can occur.

Further features (detected using TEM or SEM, for example) can be used to characterize the type of branching found in CNSs relative to structures such as Y-shaped CNTs that are not derived from CNSs. For instance, whereas Y-shaped CNTs, have a catalyst particle at or near the area (point) of branching, such a catalyst particle is absent at or near the area of branching occurring in CNSs, fragments of CNSs, fractured CNTs, elongated CNS strands, or dispersed CNSs.

In addition, or in the alternative, the number of walls observed at the area (point) of branching in a CNS, fragment of CNS, fractured CNTs, or dispersed CNSs differ from one side of the branching (e.g., before the branching point) to the other side of this area (e.g., after or past the branching point). Such a change in in the number of walls, also referred to herein as an “asymmetry” in the number of walls, is not observed with ordinary Y-shaped CNTs (where the same number of walls is observed in both the area before and the area past the branching point).

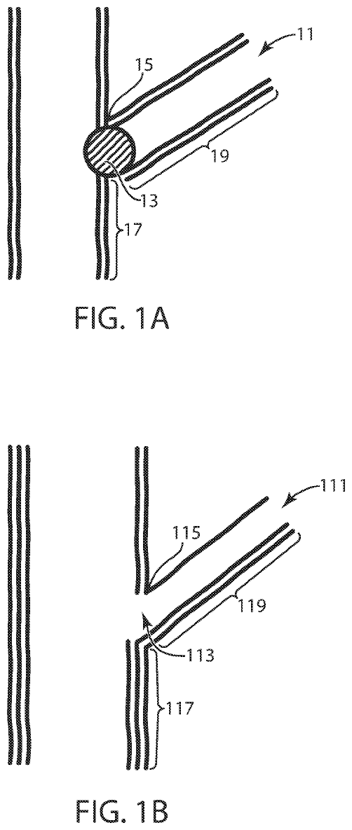

Diagrams illustrating these features are provided in FIGS. 1A and 1B. Shown in FIG. 1A, is an exemplary Y-shaped CNT 11 that is not derived from a CNS. Y-shaped CNT 11 includes catalyst particle 13 at or near branching point 15. Areas 17 and 19 are located, respectively, before and after the branching point 15. In the case of a Y-shaped CNT such as Y-shaped CNT 11, both areas 17 and 19 are characterized by the same number of walls, i.e., two walls in the drawing.

In contrast, in a CNS (FIG. 1B), a CNT building block 111, that branches at branching point 115, does not include a catalyst particle at or near this point, as seen at catalyst devoid region 113. Furthermore, the number of walls present in region 117, located before, prior (or on a first side of) branching point 115 is different from the number of walls in region 119 (which is located past, after or on the other side relative to branching point 115. In more detail, the three-walled feature found in region 117 is not carried through to region 119 (which in the diagram of FIG. 1B has only two walls), giving rise to the asymmetry mentioned above.

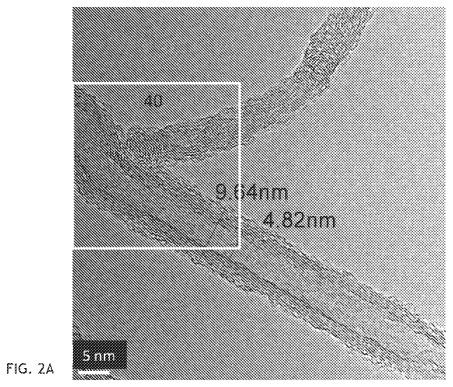

These features are highlighted in the TEM images of FIGS. 2A and 2B.

In more detail, the CNS branching in TEM region 40 of FIG. 2A shows the absence of any catalyst particle. In the TEM of FIG. 2B, first channel 50 and second channel 52 point to the asymmetry in the number of walls featured in branched CNSs, while arrow 54 points to a region displaying wall sharing.

One, more, or all these attributes can be encountered in the silicone-based compositions described herein.

Suitable techniques for preparing CNSs are described, for example, in U.S. Patent Application Publication No. 2014/0093728 A1, published on Apr. 3, 2014, U.S. Pat. Nos. 8,784,937B2; 9,005,755B2; 9,107,292B2; and 9,447,259B2. The entire contents of these documents are incorporated herein by this reference.

As described in these documents, a CNS can be grown on a suitable substrate, for example on a catalyst-treated fiber material. The product can be a fiber-containing CNS material. In some cases, the CNSs is separated from the substrate to form flakes.

As seen in US 2014/0093728A1 a carbon nanostructure obtained as a flake material (i.e., a discrete particle having finite dimensions) exists as a three-dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructure. In addition, the bulk density of the CNS can be modulated to some degree by adjusting the carbon nanostructure growth conditions, including, for example, by changing the concentration of transition metal nanoparticle catalyst particles that are disposed on the growth substrate to initiate carbon nanotube growth.

The flakes can be further processed, e.g., by cutting or fluffing (operations that can involve mechanical ball milling, grinding, blending, etc.), chemical processes, or any combination thereof.

In some embodiments, the CNSs employed are “coated”, also referred to herein as “sized” or “encapsulated” CNSs. In a typical sizing process, the coating is applied onto the CNTs that form the CNS. The sizing process can form a partial or a complete coating that is non-covalently bonded to the CNTs and, in some cases, can act as a binder. In addition, or in the alternative, the size can be applied to already formed CNSs in a post-coating (or encapsulation) process. With sizes that have binding properties, CNSs can be formed into larger structures, granules or pellets, for example. In other embodiments the granules or pellets are formed independently of the function of the sizing.

Coating amounts can vary. For instance, relative to the overall weight of the coated CNS material, the coating can be within the range of from about 0.1 weight % to about 10 weight % (e.g., within the range, by weight, of from about 0.1% to about 0.5%; from about 0.5% to about 1%; from about 1% to about 1.5%; from about 1.5% to about 2%; from about 2% to about 2.5%; from about 2.5% to about 3%; from about 3% to about 3.5%; from about 3.5% to about 4%; from about 4% to about 4.5%; from about 4.5% to about 5%; from about 5% to about 5.5%; from about 5.5% to about 6%; from about 6% to about 6.5%; from about 6.5% to about 7%; from about 7% to about 7.5%; from about 7.5% to about 8%; from about 8% to about 8.5%; from about 8.5% to about 9%; from about 9% to about 9.5%; or from about 9.5% to about 10%.

Various types of coatings can be selected. In many cases, sizing solutions commonly used in coating carbon fibers or glass fibers could also be utilized to coat CNSs. Specific examples of coating materials include but are not limited to fluorinated polymers such as poly(vinyldifluoroethylene) (PVDF), poly(vinyldifluoroethylene-co-hexafluoropropylene) (PVDF-HFP), poly(tetrafluoroethylene) (PTFE), polyimides, and water-soluble binders, such as poly(ethylene) oxide, polyvinyl-alcohol (PVA), cellulose, carboxymethylcellulose (CMC), starch, hydroxypropylcellulose, regenerated cellulose, polyvinyl pyrrolidone (PVP), and copolymers and mixtures thereof. In many implementations, the CNSs used are treated with a polyurethane (PU), a thermoplastic polyurethane (TPU), or with polyethylene glycol (PEG).

Polymers such as, for instance, epoxy, polyester, vinylester, polyetherimide, polyetherketoneketone, polyphthalamide, polyetherketone, polyetheretherketone, polyimide, phenol-formaldehyde, bismaleimide, acrylonitrile-butadiene styrene (ABS), polycarbonate, polyethyleneimine, polyurethane, polyvinyl chloride, polystyrene, polyolefins, polypropylenes, polyethylenes, polytetrafluoroethylene, elastomers such as, for example, polyisoprene, polybutadiene, butyl rubber, nitrile rubber, ethylene-vinyl acetate polymers, siloxane-based polymers including those described below, and fluorosilicone polymers, combinations thereof, or other polymers or polymeric blends can also be used in some cases. In order to enhance electrical conductivity, conductive polymers such as, for instance, polyanilines, polypyrroles and polythiophenes can also be used.

The coating material may be selected to contribute particular properties to the silicone-based composition or because of its dispersibility, compatibility, and/or miscibility with the silicone-based composition or the precursor materials used to produce it. Some implementations employ coating materials that can assist in stabilizing a CNS dispersion in an uncured silicone-based formulation and/or the matrix for a CNS masterbatch as described herein.

In many implementations, the CNSs are separated from their growth substrate and can be provided in the form of a loose particulate material (such as CNS flakes, granules, pellets, etc., for example) or in compositions that also include a coating or encapsulant and/or in the form of a granule or pellet. Specific embodiments described herein employ CNS-materials that have a 97% or higher CNT purity. Alternatively, CNS materials may include some amount of the growth substrate where it is desirable to include glass fibers in the composition.

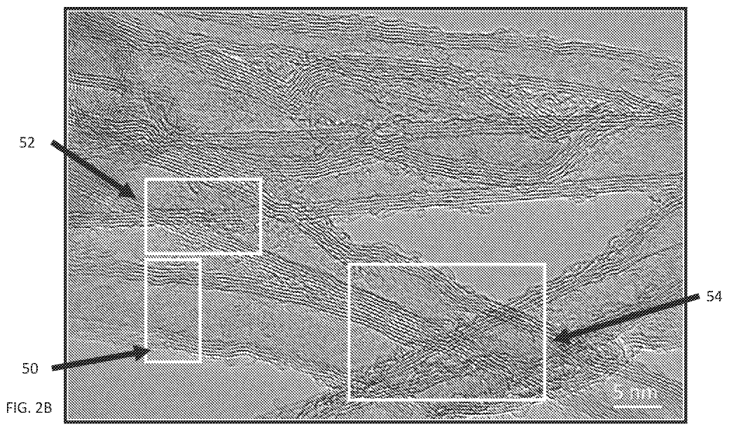

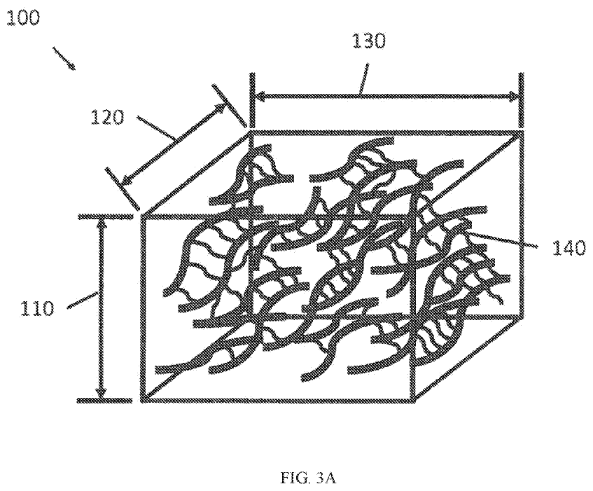

In some embodiments, the CNSs are provided in the form of a flake material after being removed from the growth substrate upon which the carbon nanostructures are initially formed. As used herein, the term “flake material” refers to a discrete particle having finite dimensions. Shown in FIG. 3A, for instance, is an illustrative depiction of a CNS flake material after isolation of the CNS from a growth substrate. Flake structure 100 can have first dimension 110 that is in a range from about 1 nm to about 35 urn thick, particularly about 1 nm to about 500 nm thick, including any value in between and any fraction thereof. Flake structure 100 can have second dimension 120 that is in a range from about 1 micron to about 750 microns tall, including any value in between and any fraction thereof. Flake structure 100 can have third dimension 130 that can be in a range from about 1 micron to about 750 microns, including any value in between and any fraction thereof. Two or all of dimensions 110, 120 and 130 can be the same or different.

For example, in some embodiments, second dimension 120 and third dimension 130 can be, independently, on the order of about 1 micron to about 10 microns, or about 10 microns to about 100 microns, or about 100 microns to about 250 microns, from about 250 to about 500 microns, or from about 500 microns to about 750 microns.

CNTs within the CNS can vary in length from about 10 nanometers (nm) to about 750 microns (μm), or higher. Thus, the CNTs can be from 10 nm to 100 nm, from 10 nm to 500 nm; from 10 nm to 750 nm; from 10 nm to 1 micron; from 10 nm to 1.25 micron; from 10 nm to 1.5 micron; from 10 nm to 1.75 micron; from 10 nm to 2 micron; or from 100 nm to 500 nm, from 100 nm to 750 nm; from 100 nm to 1 micron; from 100 to 1.25 micron; from 100 to 1.5 micron; from 100 to 1.75 micron from 100 to 2 microns; from 500 nm to 750 nm; from 500 nm to 1 micron; from 500 nm to 1 micron; from 500 nm to 1.25 micron; from 500 nm to 1.5 micron; from 500 nm to 1.75 micron; from 500 nm to 2 micron; from 750 nm to 1 micron; from 750 nm to 1.25 micron; from 750 nm to 1.5 micron; from 750 nm to 1.75 microns; from 750 nm to 2 microns; from 1 micron to 1.25 micron; from 1.0 micron to 1.5 micron; from 1 micron to 1.75 micron; from 1 micron to 2 microns; or from 1.25 micron to 1.5 micron; from 1.25 micron to 1.75 micron; from 1 micron to 2 microns; or from 1.5 to 1.75 micron; from 1.5 to 2 micron; or from 1.75 to 2 microns. In some embodiments, at least one of the CNTs has a length that is equal to or greater than 2 microns, as determined by SEM.

Shown in FIG. 3B is a SEM image of an illustrative carbon nanostructure obtained as a flake material. The carbon nanostructure shown in FIG. 3B exists as a three-dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructure. In addition, the bulk density of the carbon nanostructure can be modulated to some degree by adjusting the carbon nanostructure growth conditions, including, for example, by changing the concentration of transition metal nanoparticle catalyst particles that are disposed on the growth substrate to initiate carbon nanotube growth.

A flake structure can include a webbed network of carbon nanotubes in the form of a carbon nanotube polymer (i.e., a “carbon nanopolymer”) having a molecular weight in a range from about 15,000 g/mol to about 150,000 g/mol, including all values in between and any fraction thereof. In some cases, the upper end of the molecular weight range can be even higher, including about 200,000 g/mol, about 500,000 g/mol, or about 1,000,000 g/mol. The higher molecular weights can be associated with carbon nanostructures that are dimensionally long. The molecular weight can also be a function of the predominant carbon nanotube diameter and number of carbon nanotube walls present within the carbon nanostructure. The crosslinking density of the carbon nanostructure can range between about 2 mol/cm³ to about 80 mol/cm³. Typically, the crosslinking density is a function of the carbon nanostructure growth density on the surface of the growth substrate, the carbon nanostructure growth conditions and so forth. It should be noted that the typical CNS structure, containing many, many CNTs held in an open web-like arrangement, removes Van der Waals forces or diminishes their effect. This structure can be exfoliated more easily, which makes many additional steps of separating them or breaking them into branched structures unique and different from ordinary CNTs.

With a web-like morphology, carbon nanostructures can have relatively low bulk densities. As-produced carbon nanostructures can have an initial bulk density ranging from about 0.003 g/cm³ to about 0.015 g/cm³. Further consolidation and/or coating to produce a carbon nanostructure flake material or like morphology can raise the bulk density to a range from about 0.1 g/cm³ to about 0.15 g/cm³. In some embodiments, optional further modification of the carbon nanostructure can be conducted to further alter the bulk density and/or another property of the carbon nanostructure. In some embodiments, the bulk density of the carbon nanostructure can be further modified by forming a coating on the carbon nanotubes of the carbon nanostructure and/or infiltrating the interior of the carbon nanostructure with various materials. Coating the carbon nanotubes and/or infiltrating the interior of the carbon nanostructure can further tailor the properties of the carbon nanostructure for use in various applications. Moreover, forming a coating on the carbon nanotubes can desirably facilitate the handling of the carbon nanostructure. Further compaction can raise the bulk density to an upper limit of about 1 g/cm³, with chemical modifications to the carbon nanostructure raising the bulk density to an upper limit of about 1.2 g/cm³.

In addition to the flakes described above, the CNS material can be provided as granules, pellets, or in other forms of loose particulate material, having a typical particle size within the range of from about 1 mm to about 1 cm, for example, from about 0.5 mm to about 1 mm, from about 1 mm to about 2 mm, from about 2 mm to about 3 mm, from about 3 mm to about 4 mm, from about 4 mm to about 5 mm, from about 5 mm to about 6 mm, from about 6 mm to about 7 mm, from about 7 mm to about 8 mm, from about 8 mm to about 9 mm or from about 9 mm to about 10 mm.

Commercially, examples of suitable CNS materials are those available from Applied Nanostructured Solutions LLC (ANS) (Massachusetts, USA), a wholly owned subsidiary of Cabot Corporation.

The CNSs used herein can be identified and/or characterized by various techniques. Electron microscopy, including techniques such as transmission electron microscopy (TEM) and scanning electron microscopy (SEM), for example, can provide information about features such as the frequency of specific number of walls present, branching, the absence of catalyst particles, etc. See, e.g., FIGS. 2A-2B.

Raman spectroscopy can point to bands associated with impurities. For example, a D-band (around 1350 cm⁻¹) is associated with amorphous carbon; a G band (around 1580 cm⁻¹) is associated with crystalline graphite or CNTs). A G band (around 2700 cm⁻¹) is expected to occur at about 2× the frequency of the D band. In some cases, it may be possible to discriminate between CNS and CNT structures by thermogravimetric analysis (TGA).

In some embodiments, the CNSs are utilized in conjunction with one or more additional additives such as carbon black, CNTs, conducting particles, semiconducting particles, fumed silica, nickel coated graphite, and other additives commonly used in silicone based materials. Such additives may be combined with the silicone based composition prior to or after the CNSs are added. Where a CNS masterbatch is employed, the additional additives may be incorporated into the masterbatch or added during the letdown process.

Suitable carbon black particles may have a Brunauer-Emmett-Teller (BET) surface area from 20 to 1500 m²/g, for example, from 20 to 75 m²/g, from 75 to 150 m²/g, from 100 to 300 m²/g, from 200 to 500 m²/g, from 500 to 1000 m²/g, or from 1000 to 1500 m²/g. Alternatively or in addition, suitable carbon blacks may have an oil adsorption number of (OAN) from 30 to 350 mL/100 g, for example from 40 to 80 mL/100 g, from 60 to 150 mL/g, from 100 to 200 mL/g, from 150 to 250 mL/g, from 200 to 300 mL/g, or from 250 to 350 mL/g.

Suitable commercially available carbon black particles include carbon blacks sold under the Regal®, Black Pearls®, Spheron®, Sterling®, and Vulcan® trademarks available from Cabot Corporation, the Raven®, Statex®, Furnex®, and Neotex® trademarks and the CD and HV lines available from Birla Carbon (formerly available from Columbian Chemicals), the Ketjenblack trademark available from Lion Specialty Chemicals Co., Ltd. and the Corax®, Durax®, Ecorax®, and Purex® trademarks and the CK line available from Orion Engineered Carbons (formerly Evonik and Degussa Industries), and carbon blacks available from Denka and Timcal. Alternatively or in addition, the carbon black may be a furnace black, a gas black, a thermal black, an acetylene black, or a lamp black. The carbon black may be recycled carbon black recovered from a plastic or elastomeric material.

Carbon black may be present in any concentration in which it is typically used in silicone-based compositions not including CNSs. Typical concentrations may range from 0-30 wt %, but higher concentrations are also suitable.

In further embodiments, the CNSs can be employed in conjunction with conventional CNTs in fresh or pristine form. These CNTs are not derived from CNSs, e.g., during processing. Suitable CNTs include multiwalled CNTs (MWCNTs), single-walled CNTs (SWCNTs), and modified CNTs. SWCNTs may improve electrical conductivity, and synergy between CNSs and SWCNTs may improve electrical conductivity of silicone-based compositions containing both materials beyond what either could provide on its own at a similar loading. SWCNTs may also provide thermal conductivity. Suitable modifications to CNTs to add hydroxyl, carboxyl, amino, alkyl, halo, metal atoms, and other groups include oxidation, attachment of small molecules via diazonium chemistry, optionally followed by metallization, esterification, amidation, halogenation, addition of groups via cycloaddition, alkylation, metallization, and other modifications known to those of skill in the art. In many cases, the CNTs can be obtained commercially, including from ChengDu Organic Chemicals Co., Ltd., Sigma-Aldrich, Nanocs, Inc., and Skyspring Nanomaterials, Inc., OCSiAl, Nanocyl SA, Nano-C, Shenzhen Sanshun Nano New Materials Co., Ltd., etc. Typical loadings of CNTs are up to 20 wt %, but either or both of MWCNTs and SWCNTs may be used in any amount desired by the skilled artisan.

Silica is yet another material that can be employed in conjunction with CNSs to prepare the materials described herein. Fumed silica is commonly included in silicone-based resins to control rheology in the uncured resin, improve mechanical properties such as fracture toughness, elongation, tensile strength, modulus, and hardness in cured silicone-based compositions. Surface treatment of fumed silica can prevent crepe hardening of cured silicone-based compositions and improve compatibility of the silica with the uncured resin. Suitable surface treatments include those commonly used for fumed silica in silicone-based polymers, including hexamethyldisilazane, dimethyldichlorosilane, and siloxane based polymers such as PDMS, monohydroxyl-terminated PDMS, and dihydroxyl-terminated PDMS. Fumed silica may be surface treated prior to incorporation in the uncured silicone-based resin, or the surface treatment agent may be included in the silicone-based resin formulation. Fumed silica may be incorporated into the silicone-based resin in the proportions commonly used by those of skill in the art for silicone-based resins not containing CNSs, for example, 0-50%, 2-40%, 5-30%, or 10-25%. Moreover, the loading of silica in the silicone-based resin is independent of the presence of CNS. It has unexpectedly been found that addition of non-conductive particles such as fumed silica into CNS-containing silicone-based compositions does not affect their conductivity. The presence of the fumed silica does not interfere with the formation of conductive pathways by the CNSs and may stabilize their dispersion in various media. Without being bound by any particular theory, it is believed that the silica may physically separate the dispersed CNS-derived particles and/or, by increasing the viscosity of the uncured silicone based resin, retard reagglomeration by reducing mobility of the CNS-derived particles. Alternatively or in addition, the silica may act as dispersion media to promote deagglomeration. Silicas may have any surface area suitable for the silicone-based composition and its desired end uses, for example, any surface area from 50 to 450 m²/g. Commercially available fumed silicas suitable for use in the silicone-based compositions containing CNSs include but are not limited to CAB-O-SIL TS-530, TS-610, TS-622, M-5, TS-740, and TS-720 silicas, CLARUS 3160 silica, and Ultrabond and Ultrabond 5780 silicas available from Cabot Corporation, Aerosil 200, R972, R805, and R208 silicas sold by Evonik Industries, and silicas sold under the HDK name by Wacker Corporation.

Some compositions can include conducting or semiconducting materials to enhance conductivity. Exemplary conducting materials include metal particles, for example, silver, gold, palladium, aluminum, copper, or other conductive metals or metal alloys known to those of skill in the art. It is understood by those of skill in the art that such metals need not be 100% pure and may have varying levels of impurities so long as they remain conductive. Alternatively or in addition, the silicone-based compositions may include semiconducting metal or metal alloy particles such as silicon, doped silicon, germanium, doped germanium, gallium arsenide, and other semiconducting metals and alloys known to those of skill in the art. Alternatively or in addition, the silicone-based compositions may include semiconducting oxides such as copper oxide, barium titanate, strontium titanate, zinc oxide, and other semiconducting oxides known to those of skill in the art.

Combinations of any of these conductive and semiconducting materials may also be used. Alternatively or in addition, composite particles comprising two or more materials in which the conductive or semiconducting material is disposed on the exterior of the particle, for example, nickel coated graphite, may also be employed. The conducting or semiconducting particles may take any shape, for example, cubes, flakes, granules, irregular shapes, rods, needles, powders, spheres, or a mixture of any two or more of these. The conducting or semiconducting particles may have a median particle size (number basis) of from 1 to 200 microns as measured by laser diffraction, SEM, optical microscope, TEM, or any other device that measures particle size on a number basis. The conducting or semiconducting particles may be characterizable by a maximum particle size of 500 microns, alternatively 200 microns, alternatively 100 microns, alternatively 50 microns, alternatively 30 microns; and a minimum particle size of 0.0001 microns, alternatively 0.0005 microns, alternatively 0.001 microns. Such materials may be used in concentrations sufficient to create their own percolating networks or may be employed to enhance conduction through the network of dispersed CNSs. For example, silver containing particles are often used at loadings from 50 wt % to 70, 80 or even 80 wt %.

Alternatively or in addition, other fillers that are generally used with silicone-based materials, including but not limited to hydrophilic and surface treated precipitated silica, clays such as montmorillonite, silicon carbide and other metal carbides, metal nitrides such as BN and AlN, phosphates, sulfates, and carbonates, halides and other metal salts, metal hydroxides such as calcium and sodium hydroxide, glass fibers, glass particles, organic fibers (e.g., polymer fibers), and carbonized organic fibers may be included. As for fumed silica, non-conductive fillers may be used in the same concentration as if CNSs were not included in the composition. Other ingredients that can be present include processing aids, curing agents, photoinitiators, catalysts, additional polymers, and other components commonly used in silicone-based compositions. Ingredients such as those specified here or others, as known in the art, can be added independently, at a suitable stage of the preparation process, or as part of a silicone-based component being employed.

Silicone based materials that can benefit from incorporation of CNSs as provided herein include both siloxane polymers and silyl-terminated hybrid polymers that form linear and/or branched polysiloxane segments upon curing as well as including segments based on other chemistries, such as but not limited to acrylates, polyurethanes, epoxies, and polyethers. The siloxane segments in the hybrid resin may be part of the polymer backbone, as in a siloxane polymer, or part of a branch or side chain. The hybrid polymer can have at least two terminal groups comprising a silicon atom each independently having one, two, or three alkoxysilane groups. The alkoxysilane groups can undergo hydrolysis to form siloxane bonds (e.g., —Si—O—Si—) upon curing. Cross-linkers and catalysts may also be used to cure hybrid polymers, similarly to the chemistry described below for siloxane polymers. Exemplary hybrid polymers include those disclosed in US20180298252 and U.S. Pat. No. 9,765,247 and commercially available polymers such as SPUR® polymers available from Momentive, MS Polymers available from Kaneka Corporation, and Geniosil® polymer from Wacker Chemie AG.

Polysiloxanes, or siloxane polymers, are well recognized materials, encountered in many applications. Basic polysiloxane structures correspond to polydialkylsiloxanes, such as, for instance, linear polydimethylsiloxanes (PDMS), which can be trimethylsilyloxy-terminated:

Me₃SiO(SiMe₂O)ₙSiMe₃

where n=1, 2, 3, 4 . . . , etc.

All or a portion of the methyl groups along the chain can be substituted by various organic groups, such as linear or branched alkyl, linear or branched haloalkyl, aryl, haloaryl, alkoxy, aralkyl, and sila-cycloalkyl groups as well as more reactive groups such as alkenyl, groups such as vinyl, allyl, propenyl, butenyl, pentenyl, hexenyl, heptenyl, octenyl, nonenyl and/or decenyl groups. Linear and branched groups may have 1-100, for example, 1-12, 1-20, or 1-30 carbons. Aromatic groups may have 6-100, for example, 6-12, 6-20, or 6-30 carbons. Polar groups such as acrylate, methacrylate, amino, imino, hydroxy, epoxy, ester, alkyloxy, isocyanate, phenolic, polyurethane oligomeric, polyamide oligomeric, polyester oligomeric, polyether oligomeric, polyol, carboxypropyl, and/or halo, e.g., fluoro, groups may be attached to silicon atoms of the siloxane backbone in any combination. Alternatively or in addition, the siloxane polymer may be branched. Alternatively or in additions, siloxanes may have one or more ends terminated with any of these organic groups.

Silicone-based materials can be uncured or cured. An uncured silicone-based resin may refer to a siloxane polymer or oligomer having a structure of alternating silicon and oxygen atoms with various organic radicals attached to the silicon. Alternatively or in addition, the uncured silicone-based resin may be a hybrid polymer. An uncured silicone based resin, initially provided in the form of a liquid, gum, or gel, for example, can be cured to form a solid. Gums and other solid resins may increase their molecular weight via curing. Curing may involve the formation of cross-links or other linkages between polymer chains either at their ends or along their backbones. For example, polymer chains or branches may be formed or extended.

Various techniques can be employed to cure the silicone-containing system. The particular curing package used may depend on the composition of the silicone-containing system, as is known to those of skill in the art. Polymers with siloxane backbones may be cured using peroxides such as benzoyl peroxide, 2,4-dichlorobenzyl peroxide, t-butyl perbenzoate, dicumyl peroxide, alkyl hydroperoxides, dialkyl peroxides, and other peroxides known to those of skill in the art. Metal containing catalysts including, e.g., tin, titanium, platinum, or rhodium may be employed. Alternatively, addition-based systems employing hydrosilane materials and platinum-containing compounds may be used to cure polysiloxanes, especially vinyl-containing polysiloxanes. Amine-based curing systems may also be utilized. Condensation systems can cure on their own, at room temperature and ambient humidity. Condensation curable systems may be hydroxy-functionalized or alkoxy-functionalized. In a one-part RTV system, for example, a cross-linker exposed to ambient air moisture undergoes hydrolysis step, forming a hydroxyl or silanol group. Further condensations of the silanol with another hydrolyzable group take place until a fully cured system is obtained. Typical crosslinkers include alkoxy, acetoxy, ester, enoxy or oxime silanes. Often, methyl trimethoxy silane is used for alkoxy-curing systems and methyl triacetoxysilane for acetoxy-curing systems. A condensation catalyst can be added to fully cure the RTV system and achieve a tack-free surface. Alkoxy- or oxime-cured systems can employ organotitanate catalysts (tetraalkoxy titanates or chelated titanates, for example), while acetoxy-cured systems can utilize tin catalysts such as dibutyl tin dilaurate (DBTDL). Hybrid polymers are typically cured by hydrolysis and condensation steps in the presence of a catalyst.

Free-radical curable polymers with siloxane backbones may be alkenyl-functionalized (e.g., vinyl), and/or alkynyl functionalized. The curing or curing rate of such polymers may be improved by UV or blue light, peroxides, heat, or a combination of these.

Two-part condensation systems typically include the cross-linker or hydrosilane material and the condensation or addition (platinum) catalyst together in one part and the polymer in a second part. For addition-based curing systems, an inhibitor may be used to improve shelf life. Curing occurs as the two parts are mixed. In many formulations, the CNSs and any other fillers or pigments employed are added to the polymer.

Radiation curing using electron beams (e-beams), blue LEDs, microwaves, or UV light, typically in the presence of a photoinitiator, also can be employed.

The silicone-based component can include high temperature vulcanizing (HTV) polysiloxanes, room temperature vulcanizing (RTV) polysiloxanes, high consistency rubber (HCR) or liquid polysiloxane rubber (LSR, an abbreviation for liquid silicone rubber). Hybrid polymers or radiation curable polysiloxanes also can be employed. Hybrid polymers including silane functionalities such as silyl-modified polyethers, silyl-modified polyurethanes, and other silane-terminated and silane-modified polymers may also be used. Curing such polymers results in the formation of siloxane segments that link polymer chains together.

In general, polysiloxane rubbers are thermoset elastomers that have a backbone of alternating silicon and oxygen atoms and methyl or vinyl side groups. Known for their stability and non-reactive attributes, polysiloxane rubbers can maintain their mechanical properties, remain stable and perform in extreme conditions, e.g., temperatures from −55 to 300° C. (−67 to 572° F.). Many polysiloxane rubbers are relatively easy to manufacture and find applications in a large variety of products. The presence of methyl-groups in polysiloxane rubbers can make these materials extremely hydrophobic.

Selecting a specific silicone component can depend on various factors. One consideration, for example, will relate to the properties targeted in the final product. As known in the art, silicone-based polymers often are developed to have attributes that benefit specific type of application. Whereas enhanced adhesion, for example, may be of great importance when developing silicone-based adhesives, silicone-based polymers used to make moldable parts preferably have good mechanical properties (e.g., good tensile strength and/or hardness), while their adhesive characteristics may be of peripheral interest or even irrelevant. Foams rely on increased porosity.

Many of the embodiments described herein employ silicone-based polymers suitable for preparing CNS-containing silicone-based compositions that can be used in fabricating a product (a moldable article or part, for instance) with good mechanical stability (hardness, tensile strength) and good electrical conductivity.

In some examples, the CNS-containing silicone-based system includes a vinyl polysiloxane component that can be prepared from a liquid resin that is a vinyl functionalized polydimethylsiloxane such as, for instance, a vinyl terminated polydimethylsiloxane, typically employed as an intermediate in RTV materials. In others, the system containing CNSs and a vinyl polysiloxane is prepared using a vinyl gum, such as a dimethylmethylvinylsiloxane gum.

Various considerations may be involved in selecting a base resin. For instance, it may be found that in some cases, the base resin may not even sustain the incorporation of CNSs, yielding compositions of inadequate mixing. Thus, an important factor to consider is whether a precursor to a silicone based polymer will even form a dispersion with CNSs and, in particular, with the desired amount of CNSs (e.g., 1, 5, 10 or more wt. % CNSs relative to the total weight of the silicone-based formulation.

A further factor relates to the viscosity characterizing the uncured precursor to the silicone-based composition. As known in the art, viscosity is often a function of shear forces and can be characterized by stress strain curves. from 1 cP to 10,000 cP, from 10 cP to 50,000 cP, from 100 cP to 100,000 cP, from 25,000 cP to 200,000 cP, from 100,000 cP to 500,000 cP, from 200,000 to 700,000 cP, or from 500,000 cP to 1000000 cP.

A suitable test for dispersibility involves pressing a droplet-sized amount of material between two microscope slides by hand and observing the material in a light microscope. Suitable dispersion is achieved when no more than one bundle having a width greater than 50 microns is observed in an image containing an area of about 1000 microns×1400 microns or the equivalent area (i.e., the actual area of the portion of the specimen analyzed in the image is equivalent to 1000 microns×1400 microns). At higher loadings, the CNS-filled material may be opaque. It may be necessary to let down the material, e.g., to a loading of about 0.1 wt %, to permit observation under the microscope.

To prepare the systems described herein, CNSs can be combined with the uncured precursor of the silicone-based resin prior to curing. The process used to incorporate CNSs in the precursor material can rely on conventional compounding techniques and/or equipment. Dispersing CNSs into the precursor material can be conducted using equipment such as, for instance, Brabender type mixers, planetary mixer, Waring blender, milling (e.g., 2 roll mill), sonication, etc.

Mixing can be conducted under suitable shear forces that may depend on the amounts of CNSs added and resin properties. In many cases, a high speed mixer or an internal mixer such as a Banbury or Brabender mixer, may be used. Techniques used by those of skill in the art to combine particulate fillers with uncured silicone-based resins may be employed.

In one illustration, the final loading of CNSs in a silicone based resin is from about 0.01 to about 15 wt %, such as, for example: from 0.01 to 0.05, from 0.05 to 0.1, from 0.1 to 0.5, from 0.5 to 1, from 1 to 3, from 3 to 5, from 5 to 7, from 7 to 10, 1 to 10 wt %, 3 to 5 wt %, less than 10 wt %, less than 5 wt %, less than 1 wt %, less than 0.5 wt %, less than 0.1 wt %, less than 0.05 wt %, from 0.01% to 1 wt %, or from 10 to 15 wt %. Ranges within or overlapping these ranges also can be employed.

Preferred implementations rely on masterbatch compounding techniques to prepare a masterbatch or concentrate in which CNSs are first dispersed into a precursor of a silicone based resin. The use of a masterbatch to predisperse CNSs may allow the final composition to be produced with lower shear, especially with liquid or low molecular weight resins. The masterbatch may have a CNS loading of 0.1-15%, for example, 5-10%. The matrix of the masterbatch may be a precursor for a silicone based resin, for example, uncured hybrid polymer or a polymer having a siloxane backbone. The precursor may be in the form of a gel, gum, liquid, or solid. For two component systems, the masterbatch may be formed in either the resin component or the second component, e.g., a cross-linker or curing agent. Alternatively or in addition, the masterbatch may be prepared in a different additive, for example, a plasticizer, oil, reactive diluent, non-reactive diluent, etc. Suitable reactive diluents include but are not limited to lower viscosity (e.g., lower MW) versions of the silicone precursor in the masterbatch. Alternatively or in addition, the masterbatch may be prepared in an aqueous or non-aqueous solvent. The masterbatch may include one or more further components or additives, for example, any of the additives or fillers listed above, adhesion promoters such as silanes, and/or other additives known to those of skill in the art, to be incorporated in the final silicone-based composition.

The masterbatch may be diluted (let down) into additional CNS-free resin or with a suitable plasticizer at a suitable ratio to form a let down composition. Suitable addition ratios can range from about 0.1 wt % to about 99 wt % (based on the addition ratio of the masterbatch to the CNS-free resin or plasticizer). Exemplary addition rates are from 0.1-20 wt %, for example, 0.5-15 wt %, 1-5 wt %, 5-10 wt %, 10-20 wt %. 20-30 wt %, 30-40 wt %, or 40-50 wt % with respect to CNS-free resin. The CNS-free resin may include one or more further components or additives to be incorporated in the final silicone-based composition. Alternatively or in addition, such further components or additives may be combined with the let down composition in a further processing step.

In one illustration, CNSs are premixed with a liquid polysiloxane resin and then processed in an internal mixer, without adding peroxide curing agent, to prepare a masterbatch in which the CNS are fully dispersed. Because the CNS are fully dispersed, an appropriate amount of masterbatch and CNS-free resin, selected to generate a desired CNS content in the final curable composition, may then be mixed with other ingredients, including the curing agent and/or additional additives, without scorching the silicone-based composition and without impairing the conductive properties of the CNS.

In another illustration, CNSs are dispersed in a high viscosity polysiloxane, e.g., a solid gum, using an internal mixer, without adding peroxide curing agent, to prepare a masterbatch in which the CNS are fully dispersed. Because the CNS are fully dispersed, an appropriate amount of masterbatch and neat resin, selected to generate a desired CNS content in the final curable composition, may then be mixed with other ingredients, including the curing agent and/or additional additives, without scorching the silicone-based composition and without impairing the conductive properties of the CNS.

The same methods may be used to prepare masterbatches for two component silicone-based systems. Such systems typically include one component in which resin is combined with the catalyst and a second component in which resin is combined with the cross-linker. In these implementations, CNSs masterbatch may be let down into either or both components.

In some embodiments, the amount of CNS material to be employed in preparing the silicone-based systems described herein is at or above the percolation threshold, i.e., at or above the lowest concentration at which an insulating silicone-based material is converted into a conductive material. Without wishing to be held to any particular interpretation, it is believed that at the percolation threshold there are enough CNSs (or CNS-derived species such as CNS fragments, fractured CNTs, elongated CNS strands, or dispersed CNSs) to form an electrical pathway throughout a sample via direct conduction of electrons, via tunneling, or both.

Experimentally, the percolation threshold can be determined by measuring the volume resistivity of cured samples prepared at various loadings of CNSs to find the concentration or concentration range at which the volume resistivity changes from a value characterizing an insulator to values suitable for EMI or ESD applications. To illustrate, adding CNSs to a silicone-based resin at a loading of about 0.5 wt % can result in a reduction in volume resistivity from a magnitude of 10¹⁵ ohm·cm (for silicone-based resin with no CNSs added) to less than 10⁵ ohm·cm, for example, about less than 10⁴ ohm·cm or less than 10³ ohm·cm, for example, from 100 ohm·cm to 1000 ohm·cm.

Further applications employ a combination of CNSs and one or more additional additive (e.g., carbon black, CNTs, silica, silver flakes, nickel coated graphite, etc.) at or just above the percolation threshold for the combination.

Processing steps conducted in the preparation of the CNS-containing silicone-based systems described herein can generate CNS-derived species such as CNS fragments, fractured CNTs, elongated CNS strands, and/or dispersed CNS that become distributed (e.g., homogeneously) in individualized form throughout the system or throughout a precursor used to deliver the CNSs. For example, the shear forces associated with the compounding operation used to disperse CNSs into a precursor of the silicone-based component can result in fragmentations of the initial structures and/or the “exfoliation” of carbon nanotubes from the original CNS.

Except for their reduced sizes, CNS fragments (a term that also includes partially fragmented CNSs) generally share the properties of intact CNS and can be identified by electron microscopy and other techniques, as described above. Fractured CNTs, elongated CNS strands, and dispersed CNSs can be formed when crosslinks between CNTs within the CNSs are broken, under appropriate amounts of applied shear, for example.

Illustrative CNS fragment sizes present in a CNS-containing silicone-based system can be within the range of from about 0.5 to about 20 μm, e.g., within the range of from about 0.5 to about 1 μm; from about 1 to about 5 μm; from about 5 to about 10 μm; from about 10 to about 15 μm; or from about 15 to about 20 μm. In some cases, reducing the fragment size too much, e.g., to less than 0.5 μm, can compromise the electrical properties associated with utilizing CNSs. If used, carbon black particles and/or CNTs can be within a range of from about 0.1 micron to about 10 microns.

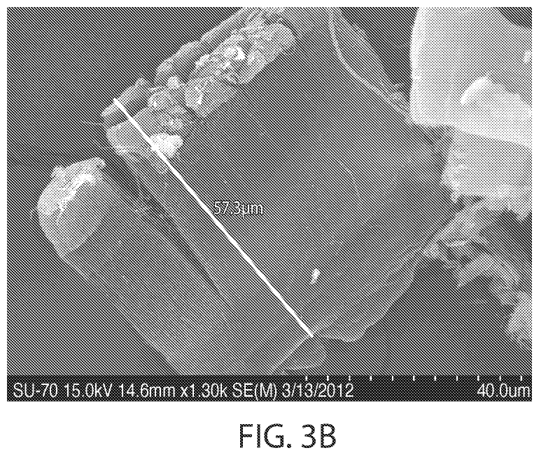

In many of the cured products, the CNSs and/or CNS-derived species are uniformly distributed throughout the silicone-based matrix, as seen, for instance, in the optical microscope image of FIG. 4.

The curing process can be conducted following the procedures and curing agents, catalysts, crosslinker, inhibitor, photoinitiators, etc. typically used by those of skill in the art for the specific silicone-based system being employed. In certain embodiments, cured silicone-based polymers can be subjected to post-curing, in which the cured silicone is further heated in an oven set to a specified temperature for a specified amount of time. Any combination of times and temperatures for post-curing known to those of skill in the art are appropriate, for example, two hours at 177° C., two hours at 200° C., or four hours at 200° C.

Many aspects of the invention relate to moldable compositions obtained, for example, by conducting the curing step in a suitable molding process, via extrusion processes or injection molding. Curable silicone based compositions may be molded, cured, and shaped by any technique suitable for silicone-based polymers known to those of skill in the art.

Once cured, the CNS-containing silicone-based systems described herein can have a tensile strength greater than 0.5 MPa, for example, from 0.5 MPa to 10 MPa and/or an elongation at break from 40% to 300%, for example, from 45% to 120%, both as measured according to ASTM D412.

Some aspects of the invention pertain to a cured composition that contains a silicone-based component and CNSs, fragments of CNSs, fractured CNTs, elongated CNS strands, and/or dispersed CNS and is not a foam. In fact, in some examples, measures are taken to minimize the incorporation of air (or another gas) during manufacture. In general, it is desirable that there be no air bubbles observable to the unaided eye (e.g., about 0.1 mm or greater) in the fracture surface of a sample.

Lightweight materials are important for some applications, EMI or ESD shielding, for example. In this respect, cured silicone-based systems containing CNSs, fragments of CNSs, fractured CNTs, elongated CNS strands, and/or dispersed CNSs can have a density of 2 g/cm³ or less, for example, 1.5 g/cm³ or less or 1.2 g/cm³ or less, preferably while achieving a shielding efficiency for a 2 mm thick sample of at least 35 dB, for example, at least 40 dB, at 1.5 GHz.

In some embodiments, a cured composition containing CNSs, fragments of CNSs, fractured CNTs, elongated CNS strands, and/or dispersed CNS distributed in a silicone-based polymer can be characterized by its volume (or bulk) resistivity (i.e., a material's resistance to leakage current through its body, calculated by the ratio of the potential gradient in relation to the current in a material with the same density. A direct-current resistance between opposing faces of a one-meter cube of the material numerically equates to volume resistivity in SI (ohm·m or ohm·cm). A protocol for measuring volume resistivity is provided in ASTM-D257-07.

In some implementations, the volume resistivity (VR) of a cured material such as described herein is characteristic of an electrical conductor, semi-conductor, or insulator. In other implementations, a cured system containing silicone-based polymer and CNSs, fragments of CNSs, fractured CNTs, elongated CNS strands, and/or dispersed CNSs can have a volume resistivity that is less than about 10¹¹ ohm·cm, for instance, less than 10⁸ ohm·cm, less than 10⁷ ohm·cm, less than 10⁶ ohm·cm, less than about 10⁴ ohm·cm, less than 1000 ohm·cm, or less than about 100 ohm·cm. In specific examples, a cured silicone-based system including CNSs, fragments of CNSs, fractured CNTs, elongated CNS strands, and/or dispersed CNSs has a bulk resistivity that is less than about 50 ohm·cm, less than 35 ohm·cm, less than 10 ohm·cm or less than 5, less than 4, less than 3 or less than 2 or less than 1 ohm·cm.

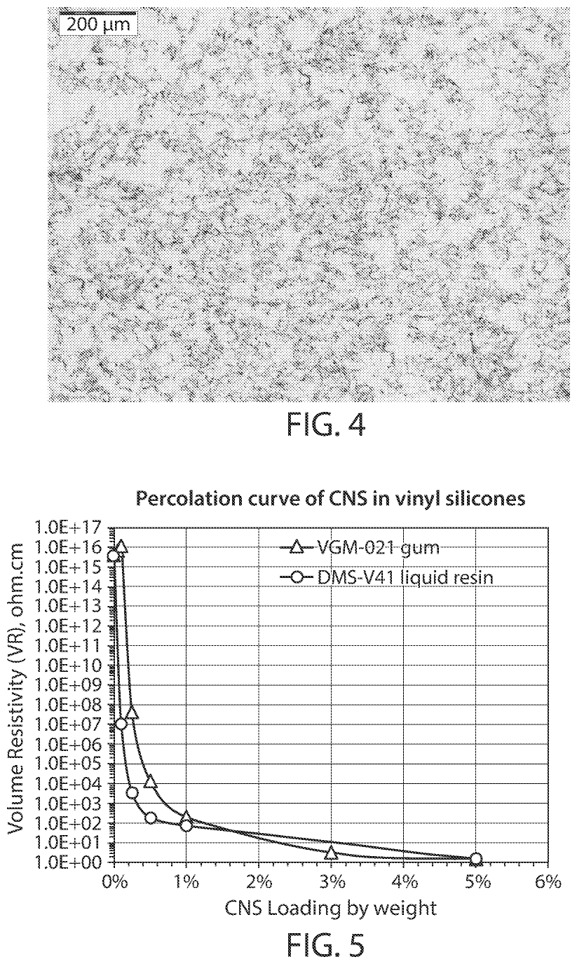

Illustrative plots of the volume resistivity of two vinyl siloxanes containing dispersed CNSs and/or CNS-derived species, prepared at various CNS loadings, are shown in FIG. 5.

As known in the art, EMI shielding can take place through one or more of the following mechanisms: reflection, absorption and multiple reflections. For EMI shielding applications, the cured silicone-based polymer-CNSs systems described herein can be characterized by their shielding effectiveness (“SE”), a parameter expressed in decibels (dB) and defined in terms of the ratio between the incoming power (Pi) and outgoing power (Po) of an electromagnetic wave according to the following equation:

SE=10 log(Pi/Po)

A suitable test to assess the SE of a cured silicone-based system containing CNSs, fragments of CNSs, fractured CNTs, elongated CNSs, and/or dispersed CNSs is that specified in ASTM D4935.

It was discovered that the presence of CNSs, fragments of CNSs, fractured nanotubes, elongated CNS strands, and/or dispersed CNS in cured silicone-based compositions can display improved EMI shielding relative to a comparative cured silicone-based composition prepared without CNSs (and also without adding other conductive additives such as carbon black, CNTs, silica or silver flakes). Improved EMI shielding is maintained even when CNSs are used in combination with fillers that do not contribute to EMI shielding such as carbon black or fumed silica.

Compositions described herein can be used in preparing various molded articles, elastomers, coatings, potting or gap filling formulations, gasketing, films or membranes, aircraft, space or automotive parts, turbine or other engine components, boat or ship parts, turbine blades, medical equipment and so forth.

The invention is further illustrated by the following non-limited examples.

### EXAMPLES

Conductivity Test

A Voltmeter-ammeter (DC-amplification, electrometer) was used to measure volume resistance Rv up to 10⁶ ohm or volume resistivity up to 10⁶ ohm·cm. The system employs a measurement method which conforms to ASTM D257-07 to conduct the volume resistance/resistivity test.

The sample was cured in a mold with a dimension of 2.5 inches×0.5 inches×0.05 inches (63.5 mm×12.7 mm×1.18 mm), at 180° C. for 10 min under 20,000 pounds in a hot press. This was followed by cooling the mold in a press at 20 tons force for 5 minutes. The cooling press was maintained at a temperature no greater than 50° F. (10° C.). After curing, the sample was cooled down in a cold press under 20,000 pounds, following which the sample thickness (t) and width (W) were measured accurately.

Prior to the conductivity test, a layer of silver paint was applied to both ends of molded bars, and dried for 20 min at 23° C. The molded bar (sample) was clamped between two brass electrodes which were 43 mm apart (L).

The electrical resistance (ohm) was measured between the painted electrodes using a voltmeter-ammeter.

Volume resistivity was calculated using the following equation:

ρᵥ=(Rᵥ×A)/L(ohm·cm), where A=W×t(cm²).

A Keithley 6517A resistance meter with a Keithley 8009 resistivity text fixture was used to measure volume resistance Rv exceeding 10⁶ ohm or volume resistivity exceeding 10⁶ ohm·cm according to ASTM D257-07.

The polymer sample was cured in a circular die with a diameter of 2 mm and thickness of 2 mm. The curing condition was same as for samples having a volume resistance up to 10⁶ ohm or volume resistivity up to 10⁶ ohm·cm. Volume resistivity was measured according to the Keithley Model 8009 Resistivity Test Fixture Instruction Manual. The alternating voltage was set as 5-10 V. The average result from 8 tests per specimen was recorded.

EMI Shielding Test

The Electromagnetic Interference (EMI) Shielding Effectiveness (SE) test standard ASTM D4935-1 was used to evaluate the cured elastomer compounds, in the frequency range of 30 MHz to 1.5 GHz. The configuration of the cured elastomer samples for EMI shielding testing conformed to ASTM D4935. The EMI testing samples were punched out from a 6 in.×6 in (15 cm×15 cm) silicone-based plaque cured at 180° C. for 20 min under 20,000 pounds in a hot press. This was followed by cooling the mold in a press at 20 tons force for 5 minutes. The cooling press was maintained at a temperature no greater than 50° F. (10° C.). Additional EMI shielding efficiency tests according to IEEE standard 299 were done in the frequency range of 2.0 GHz to 18 GHz on test plaques as molded. The thickness of the cured samples was 1-2 mm. Precise dimensions were measured as a factor of the efficiency measurement. The test instrument was equipped with a signal generator (Marconi, Model 10874-83-1), spectrum analyzer (Hewlett Packard, Model 8564E), ASTM shielding effectiveness test fixture (Electro Metrics, EM-2107A), and Quantum Change Tile software (Version 3.4.k.6) installed on a computer. Shielding effectiveness (SE) was measured in decibels (dB).

The measuring and test equipment utilized in the performance of these tests was calibrated in accordance with ANSI/NCSL Z540-3-2006, by Keystone Compliance, LLC, utilizing reference standards or interim standards whose calibrations had been certified as being traceable to the National Institute of Standards & Technology (NIST).

Mechanical Property Test

Samples were cured in a mold at 180° C. for 10 min under 20,000 pounds in a hot press to form 2 mm thick samples. After curing, samples were cooled down in a cold press under 20,000 pounds. Dumbbell shaped samples were punched using a Die-C standard die. Tensile properties were measured according to ASTM D412; the strain rate was 500 mm/min.

Dispersibility Test

A portion of an uncured sample was collected, weighed, and letdown to a total CNS loading of 0.1% with neat uncured silicone-based resin having approximately the same viscosity as the resin used to prepare the sample. A droplet-sized amount of material was collected from the letdown and pressed between two microscope slides by hand. An image was collected at 200× and had dimensions of approximately 1000 microns×1400 microns. Where necessary, the width of carbon nanostructure fragments was measured by hand or using image analysis software. Dispersion was acceptable when no more than one fragment of a carbon nanostructure having a bundle width greater than 50 microns was observed.

### Examples 1-9

The curable silicone-based compounds were prepared according to the following mixing procedure. Vinyl functionalized polydimethylsiloxane (VGM-021 Dimethylmethylvinylsiloxane gum, 0.2-0.3% vinylmethylsiloxane, Gelest) were mixed with fillers as noted in Table 1 below in a 680 cc Brabender mixer with roller blades (60° C., 60 rpm, fill factor 0.7) for 8 min. to form a dispersion in a first mixing pass and then cooled to room temperature. The carbon black was VULCAN XC72R from Cabot Corporation. CAB-O-SIL TS-530 fumed silica is also available from Cabot Corporation. Nickel-coated graphite (NiGr; E-Fill 2701) was obtained from Oerlikon Metco. FS8 grade silver flakes were obtained from Johnson Matthey. PEG-coated CNS were obtained from Cabot Corporation. In the second pass, the corresponding amount of peroxide catalyst (Luperox® 101XL45) was added to the compound from the first pass and mixed for an additional two minutes under the same conditions. The resulting material was cooled to room temperature and processed for two minutes on a two-roll mill to create a curable sheet.

TABLE 1
Curable vinyl siloxane composition of Examples 1 to 9.

| Example | 1 | 2 | 3 | 4 | 5 | 6 | 7 | 8 | 8C | 9 |
|---|---|---|---|---|---|---|---|---|---|---|
| Filler | Carbon | CNS | CNS | CNS | CNS + | Fumed | CNS + | CNS + | Ni-Gr | Silver |
| | black | | | | Carbon | silica | Fumed | Ni-Gr | | flakes |
| | | | | | black | | Silica | | | |
| VGM-021 | 77.7% | 96.8% | 94.2% | 92.3% | 74.8% | 87.4% | 84.5% | 46% | 48.9% | 48.9% |
| gum | | | | | | | | | | |
| Peroxide | 2.3% | 2.2% | 2.8% | 2.7% | 2.2% | 2.6% | 2.5% | 1.0% | 1.1% | 1.1% |
| Carbon Black | 20.0% | — | — | — | 20.0% | — | — | — | — | — |
| CNS | — | 1.00% | 3.0% | 5.00% | 3.0% | | 3.0% | 3.0% | — | — |
| Ni-Gr | — | — | — | — | — | | — | 50.0% | 50.0% | — |
| Silver | — | — | — | — | — | — | — | — | — | 50.0% |
| Fumed silica | — | — | — | — | — | 10.0% | 10.0% | — | — | — |

TABLE 2
Cured vinyl siloxane properties for Examples 1 to 9.

| Example | 1 | 2 | 3 | 4 | 5 | 6 | 7 | 8 | 8C | 9 |
|---|---|---|---|---|---|---|---|---|---|---|
| Filler package | Carbon | CNS | CNS | CNS | CNS + | Fumed | CNS + | CNS + | Ni-Gr | Silver |
| | Black | | | | Carbon | Silica | Fumed | Ni-Gr | | flakes |
| | | | | | Black | | Silica | | | |
| VR* (ohm · cm) | 695 | 559 | 3.21 | 1.38 | 0.56 | 2.0 × 10¹⁵ | 3.35 | 0.48 | 1.84 | 0.025 |
| SE (dB, 50 MHz)^{a} | 1 | 5 | 30 | 34 | 35 | — | 31 | — | 11 | 58 |
| SE (dB, 500 MHz)^{a} | 2 | 12 | 31 | 36 | 37 | — | 33 | — | 10 | 62 |
| SE (dB, 1.0 GHz)^{a} | 3 | 13 | 32 | 38 | 40 | — | 35 | — | 10 | 61 |
| SE (dB, 1.5 GHz)^{a} | 3 | 16 | 34 | 40 | 43 | — | 44 | — | 12 | 60 |
| SE (dB, 10 GHz)^{b} | 7 | 25 | 53 | 70 | 70 | — | 59 | 87 | 27 | 71 |
| SE (dB, 15 GHz)^{b} | 8 | 32 | 66 | 86 | 74 | — | 71 | 95 | 34 | 76 |
| Density (g/cm³) | 1.08 | — | 1.04 | 1.04 | 1.11 | — | 1.10 | — | 1.60 | 1.80 |
| Tensile Strength | 5.1 | 1.4 | 3.6 | 6.8 | 6.0 | 1.1 | 7.0 | 4.7 | 0.55 | 0.74 |
| (MPa) | | | | | | | | | | |
| Elongation at | 235 | 104 | 54 | 45 | 57 | 237 | 57 | 37 | 66 | 189 |
| Break (%) | | | | | | | | | | |

*VR—Volume Resistivity
^{a}ASTM D4935 method
^{b}IEEE 299 method

### Examples 10-15

The curable silicone-based compounds in Examples 10-15 were prepared by combining a masterbatch (MB) with a high viscosity vinyl siloxane gum. A 5% CNS masterbatch (MB) was prepared by dispersing CNS particles directly into VGM-021 polysiloxane vinyl gum as described in Table 3 using a 680 cc Brabender mixer with roller blades (60° C., fill factor 0.7, 60 rpm for 8 min) and then cooled to room temperature. The 5% CNS MB mix was further processed on a two-roll mill for another 2 min to form a masterbatch sheet. Samples were cut from the masterbatch sheet and weighed to prepare letdown samples with a final CNS loading between 0.05% and 1.0%. For Examples 11-15, the 5% CNS masterbatch sample was mixed with additional vinyl gum as noted in Table 4 in the Brabender mixer (60° C., fill factor 0.7, 60 rpm for 8 min), following which Luperox® 101XL45 peroxide catalyst was added to the mixture. The final composition was mixed for two minutes in the Brabender mixer (60° C., fill factor 0.7, 60 rpm), transferred to a two-roll mill, and processed for two minutes to create a curable silicone-based sheet. Volume resistivity of the samples was measured and listed in Table 5. Example 11 prepared via a masterbatch route exhibits lower resistivity than Example 2 prepared by directly mixing CNS into polysiloxane rubber gum, indicating that the masterbatch route can lead to a superior product. The high level of dispersion of the CNSs in Example 11 is illustrated in FIG. 4.

TABLE 3
CNS Masterbatch (5%) in vinyl gum

| | | Example | |
|---|---|---|---|
| | | 10 | |
| Ingredients | Grades | Grams | % |
| Siloxane rubber | VGM-021 gum | 276.0 | 95.0 |
| Conductive additive | CNS | 14.5 | 5.0 |

| | | |
|---|---|---|
| Total | 290.5 | 100.0 |

TABLE 4
CNS letdown formulation in vinyl gum, Examples 11-15

| Example | 11 | 12 | 13 | 14 | 15 |
|---|---|---|---|---|---|
| CNS target loading | 1.0% | 0.50% | 0.25% | 0.10% | 0.05% |
| VGM-021 gum | 77.2% | 87.2% | 92.1% | 95.1% | 96.1% |
| 5% CNS MB | 20.0% | 10.0% | 5.0% | 2.0% | 1.0% |
| Peroxide | 2.8% | 2.9% | 2.9% | 2.9% | 2.9% |
| Total | 100.00% | 100.00% | 100.00% | 100.00% | 100.00% |

TABLE 5
Cured HTV elastomer properties of Examples 11-15

| Example | 11 | 12 | 13 | 14 | 15 |
|---|---|---|---|---|---|
| CNS loading | 1.0% | 0.50% | 0.25% | 0.10% | 0.05% |
| VR (ohm · cm) | 2.13 × | 1.41 × | 4.36 × 10⁷ | 1.21 × 10¹⁶ | 6.76 × 10¹⁵ |
| | 10² | 10⁴ | | | |
| Tensile | 1.4 | 1.3 | 1.0 | 0.7 | 0.6 |
| Strength (MPa) | | | | | |
| Elongation | 104 | 138 | 147 | 143 | 141 |
| at Break (%) | | | | | |

### Example 16

A curable silicone-based compound was prepared using liquid siloxane resin as follows. Vinyl functionalized polydimethylsiloxane (DMS-V41 vinylmethylsiloxane, molecular weight 62,700 g/mol, Gelest, Inc.) was premixed with CNS pellets according to the formulation in Table 6 in a Flacktek Max 200 Long cup (Part number 501-220LT, Flacktek, Inc) and mixed with a DAC 600 Speedmixer® (Flacktek, Inc) at 1500 RPM for 15 seconds. The CNS-siloxane premix paste was mixed in a Brabender mixer in a first mixing pass for 8 min (60° C., 60 rpm, fill factor 0.7) to disperse the CNSs in the resin and then cooled to room temperature. In a second mixing pass, the corresponding amount of Luperox® 101XL45 peroxide catalyst was added to the Brabender mixer and the formulation mixed under the same conditions as for the first pass for two minutes, following which the material was transferred to a two-roll mill and processed for two minutes to create a curable sheet. The final curable polysiloxane composition is listed in Table 6.

TABLE 6
CNS (5%) dispersed in liquid silicone cured by peroxide

| | | Example | |
|---|---|---|---|
| | | 16 | |
| Ingredients | Grades | Grams | % |
| Siloxane rubber | DMS-V41 liquid | 288.9 g | 92.9 |
| Conductive additive | CNS | 15.54 g | 5.0 |
| Curing agent | Peroxide | 6.42 g | 2.1 |

| | | |
|---|---|---|
| Total | 310.9 g | 100.0 |

### Examples 17-21

The curable silicone-based compounds in Examples 18-21 were prepared by combining a masterbatch (MB) with a liquid siloxane (DMS-V41 liquid siloxane resin, Gelest, Inc.). A 5% CNS masterbatch (Example 17) was prepared using the formulation of Table 7 and the method of Example 16. Samples were cut from the masterbatch sheet and weighed to prepare letdown samples with a final CNS loading between 0.05% and 1.0%. To prepare the letdowns of Examples 18-21, the cut and weighed 5% CNS masterbatch sample was mixed with additional vinyl gum (formulation in Table 8; total batch size 165 g) in a Flacktek DAC 600 planetary speed mixer. The mixing was performed in multiple runs as follows: two 30 s runs at 1500 rpm, five 60 s runs at 1500 rpm, two 30 s runs at 2000 rpm, and three 60 s runs at 2000 rpm. The sample was cooled in between runs to prevent heat buildup that could accelerate cure or reduce viscosity. Once the masterbatch was fully dispersed in the letdown, Luperox® 101XL45 peroxide catalyst was added as described in Table 8 and the final composition further mixed in the planetary mixer for two one minute intervals at 1500 rpm. During each mixing run, the temperature was monitored and kept below 80° C. Between the two mixing runs, the sample was cooled down to room temperature to avoid overheating. During the second mixing run, the mixing speed was lowered to avoid generating new air bubbles and a vacuum was used to remove existing air bubbles from the sample. After mixing, the letdown mixes were transferred to a two-roll mill and processed for two minutes to create a curable sheet. Volume resistivity and shielding efficiency for the samples are reported in Table 9.

TABLE 7
CNS Masterbatch (5%) preparation in vinyl liquid resin
Example 17

| Ingredients | Grams | % |
|---|---|---|
| Siloxane rubber | 276.0 g | 95.0 |
| Conductive additive | 14.5 g | 5.0 |
| Total | 290.5 g | 100.0 |

TABLE 8
CNS letdown formulation
in liquid siloxane resin, Examples 18-21

| | | Example | | | |
|---|---|---|---|---|---|
| | | 18 | 19 | 20 | 21 |
| | | CNS target loading (%) | | | |
| | | 1.0 | 0.50 | 0.25 | 0.10 |
| Ingredients | Grades | % | % | % | % |
| Siloxane rubber | DMS-V41 liquid | 77.9 | 87.9 | 92.9 | 95.8 |
| Masterbatch | 5% CNS MB | 20.0 | 10.0 | 5.0 | 2.0 |
| Curing agent | Peroxide | 2.1 | 2.1 | 2.1 | 2.2 |

| | | | | |
|---|---|---|---|---|
| Total | 100.0 | 100.0 | 100.0 | 100.0 |

TABLE 9
Cured polysiloxane properties of Examples 16-21

| Example | 16 | 18 | 19 | 20 | 21 |
|---|---|---|---|---|---|
| CNS % | 5.0% | 1.0% | 0.50% | 0.25% | 0.10% |
| VR (ohm · cm) | 1.5 | 77.5 | 202 | 3.75 × 10³ | 1.14 × 10⁷ |
| SE (dB, 50 MHz) | 30 | 12 | Not | Not | Not |
| SE (dB, 500 MHz) | 31 | 14 | tested | tested | tested |
| SE (dB, 1.0 GHz) | 32 | 15 | | | |
| SE (dB, 1.5 GHz) | 34 | 17 | | | |
| Tensile Strength | 2.6 | Not | | | |
| (MPa) | | tested | | | |
| Elongation at | 45 | Not | | | |
| Break (%) | | tested | | | |

### Examples 22-23

Example 22-23 were prepared with platinum-cured (Pt-cured) liquid siloxane rubber (LSR) according to the formulations listed in Table 10. Either neat LSR resin (DMS-V41 siloxane resin, Gelest, Inc.) or masterbatch prepared according to Example 17 was combined with CAB-O-SIL TS-530 fumed silica (Cabot Corporation).

A blank (CNS-free) Pt-curable silicone-based compound was using a Flacktek DAC 600 planetary speed mixer fitted with a DAC 200 mixer cup. TS-539 fumed silica was combined with DMS-V41 resin for five minutes at 2000 rpm. The silica-silicone-based dispersion was cooled to room temperature. HMS-301 cross linker and SIT 7900.2 inhibitor (both from Gelest, Inc.) were added to the mixture and dispersed for one minute at 2000 rpm. Finally, a platinum catalyst (platinum(0)-1,3-divinyl-1,1,3,3-tetramethyldisiloxane complex solution, CAS #68478-92-2) was added and the final formulation mixed for 30 seconds under vacuum at 1000 rpm. The resulting curable silicone-based sample was cured in a compression mold as described above to produce samples for mechanical testing and resistivity measurements. Volume resistivity and shielding efficiency are reported in Table 11.

TABLE 10
Pt-Curable LSR formulation

| | Example 22 | | Example 23 | |
|---|---|---|---|---|
| Ingredients | Grams | % | Grams | % |
| Masterbatch of Example 17 | 0.00 | 0.00 | 174.00 | 59.95 |
| DMS-41 liquid siloxane resin | 100.00 | 87.14 | 78.98 | 27.21 |
| TS-530 silica | 11.48 | 10.00 | 29.00 | 10.0 |
| HMS-301 | 2.84 | 2.48 | 6.94 | 2.40 |
| SIT 7900.2 Inhibitor | 0.25 | 0.22 | 0.62 | 0.21 |
| Pt catalyst | 0.19 | 0.16 | 0.68 | 0.23 |
| Total | 114.76 | 100.00 | 290.22 | 100.00% |

TABLE 11
Platinum-Curable LSR formulation

| Example | 22 | 23 |
|---|---|---|
| CNS % | 0.0% | 3.0% |
| VR (ohm · cm) | 2.64 × 10¹⁵ | 1.96 |
| SE (dB, 50 MHz) | Not tested | 41 |
| SE (dB, 500 MHz) | | 45 |
| SE (dB, 1.0 GHz) | | 49 |
| SE (dB, 1.5 GHz) | | 54 |
| SE (dB, 10 GHz) | | 58 |
| SE (dB, 15 GHz) | | 70 |

A platinum-curable LSR compound containing CNS was prepared using a masterbatch process. The 5% CNS-polysiloxane masterbatch of Example 17 was cut and weighed to prepare the letdown sample of Example 23. Masterbatch, additional polysiloxane, and TS-530 silica in the amounts indicated in Table 10 were combined in a 680 cc Brabender mixer with roller blades (60° C., 60 rpm, fill factor 0.7) for 8 min. to form a dispersion in a first mixing pass and then cooled to room temperature. In a second pass, the corresponding amount of crosslinker and inhibitor were added to the compound from the first pass and mixed for an additional four minutes in the Brabender mixer (room temperature, 60 rpm, fill factor 0.7). The material was cooled to room temperature. In the final mixing step on the Brabender, the corresponding amount of catalyst was added into the mixer and mixed for two minutes (room temperature, 60 rpm, fill factor 0.7). The curable silicone mix was processed for two minutes in a two-roll mill to create a curable silicone sheet. The resulting curable polysiloxane sample was cured in a compression mold as described above to produce samples for mechanical and resistivity testing. Volume resistivity and shielding efficiency are reported in Table 11.

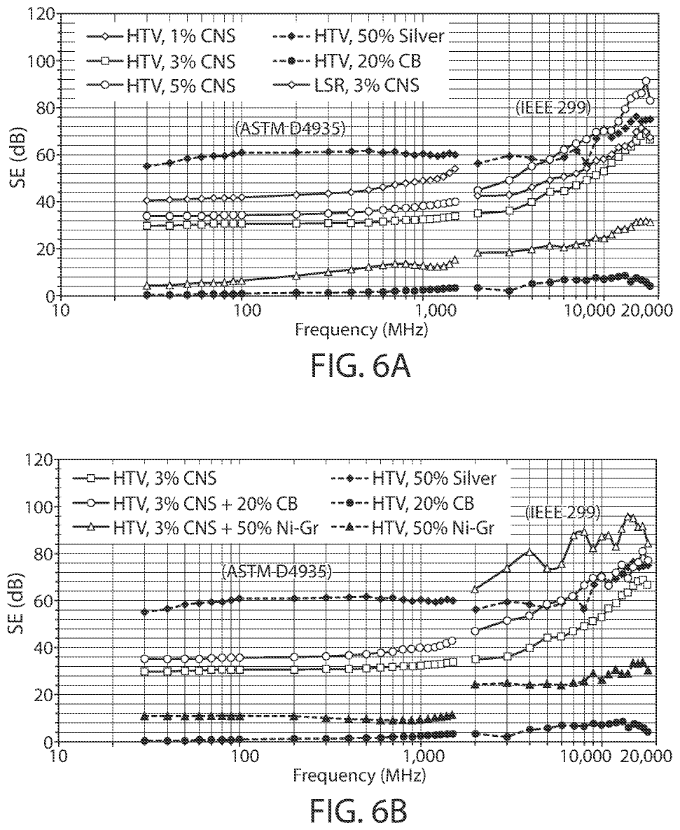

FIG. 5 shows percolation curves for the CNS-containing silicone-based samples of Examples 11-16 and 18-21. The data show that electrical conductivity is not dramatically impacted by either the choice of catalyst or the addition of silica. Resistivity is dramatically reduced with the addition of even small amounts of CNSs and continues to decrease even after percolation is achieved. FIG. 6 shows the variation of shielding efficiency with frequency for various experimental (open symbols) and comparative (closed symbols) examples. The results show that CNS provides superior shielding capability and that this shielding is even more pronounced at high frequencies.

### Example 24

A curable hybrid polymer formulation is prepared by combining a masterbatch with additional silyl-terminated prepolymer. A 5% CNS masterbatch is prepared by premixing CNS particles directly into KANEKA MS POLYMER® 5303H silyl-terminated polyether resin as in Example 16, and then dispersed using a 680 cc Brabender mixer equipped with roller blades (60° C., fill factor 0.7, 60 rpm for 8 min) under a nitrogen blanket. The masterbatch is then cooled to room temperature, and samples are cut and weighed to prepare letdown samples with a final CNS loading from 0.05% to 5.0%. Sample weighing and sampling are performed in a moisture controlled dry box (e.g., RH<3%). For a final CNS loading of 1%, a masterbatch sample is combined with additional S303H polymer (total polymer 57 wt %), CAB-O-SIL TS-530 hydrophobic silica (10 wt %, Cabot Corporation) and polypropylene glycol plasticizer (PPG3000, 31.4 wt %, Sigma-Aldrich). Fumed silica is first dried at 105° C. for 2 hour to remove moisture. The components are blended in a Flacktek DAC 600 planetary speed mixer at 2000 rpm for a total of 10 minutes in one minute intervals between which the samples were cooled to prevent heat build up that could accelerate cure or lower viscosity. Dibutyl tin catalyst (0.6 wt %) is added to the mixture, and the complete mix (total mass=165 g) is then further mixed for another 2 min at 1500 rpm. The moisture-curable compound is filled into a cartridge or molded at room temperature. The sample can be cured at room temperature by moisture (23° C., 50% RH for 7d) to provide a material having high conductivity and desirable mechanical properties.

### Example 25

A curable two part (“A” and “B”) silicone formulation is prepared by combining a masterbatch with additional vinyl functionalized silicone with another part containing a cross linking silicone. A 5% CNS masterbatch is prepared by premixing CNS particles directly into the DMS-V41 silicone as described in Example 16, and then dispersed using a 680 cc Brabender mixer equipped with roller blades (60° C., fill factor 0.7, 60 rpm for 8 min) under a nitrogen blanket. The masterbatch is then cooled to room temperature, and samples are cut and weighed to prepare letdown samples with a final CNS loading from 0.05% to 5.0% and 0.19% (based on the total mass of silicone in the final A+B formulation) platinum (0)-1,3-divinyl-1,1,3,3-tetramethyldisiloxane complex solution. The letdown is prepared by blending the components in a Flacktek DAC 600 planetary speed mixer at 2000 rpm for a total of 10 minutes in one minute intervals between which the samples are cooled to prevent heat build up that could reduce mixing efficiency or decompose components.

The “B” component contains a mixture of the 5% CNS masterbatch, polymethylhydrosiloxane (trimethylsilyl-terminated, HMS-992 siloxane, Gelest), and sufficient neat DMS-V41 silicone to achieve the desired CNS loading (0.05-5.0%) and a DMS-V41/HMS-992 ratio of 10:1 (mass basis) when the “A” and “B” components are combined in a 1:1 ratio. The components are mixed in a Flacktek DAC-600 planetary speed mixer as for the “A” component. Care must be given to the “B” part to ensure moisture has been excluded during every step of the mix, as it can initiate a crosslinking reaction with the hydrosilane and reduce its activity. The “A” and “B” components are blended by hand in a 1:1 ratio and cured at room temperature and typical room conditions (23° C., 10-50% RH) to provide a material having high conductivity and desirable mechanical properties.

While this invention has been particularly shown and described with references to preferred embodiments thereof, it will be understood by those skilled in the art that various changes in form and details may be made therein without departing from the scope of the invention encompassed by the appended claims.

1. A cured polymer composite, comprising:
a cured polymer comprising a cured siloxane polymer or a cured silyl-terminated hybrid polymer, and
at least one CNS-derived material dispersed in the cured polymer and selected from the group consisting of: carbon nanostructures, fragments of carbon nanostructures, fractured carbon nanotubes, elongated CNS strands, dispersed CNSs, and any combination thereof,
wherein the carbon nanostructures or fragments of carbon nanostructures include a plurality of multiwall carbon nanotubes that are crosslinked in a polymeric structure by being branched, interdigitated, entangled and/or sharing common walls,
wherein the fractured carbon nanotubes are derived from the carbon nanostructures and are branched and share common walls with one another,
wherein elongated CNS strands are derived from the carbon nanostructures and include CNTs that have been displaced linearly with respect to one another, and
wherein the dispersed CNS comprise exfoliated fractured CNTs that do not share common walls with one another.

2. The cured polymer composite of claim 1, wherein the composition comprises 0.01 to 15 wt % of CNS-derived material.

3. The cured polymer composite of claim 1, wherein the siloxane polymer comprises Me₃SiO (SiMe₂O)ₙ Me, wherein n is at least 2, wherein at least one methyl group is optionally substituted with a group selected from R′ and —(O—SiR′R″)ₙ—, wherein R′ and R″ are independently linear or branched alkyl, linear or branched haloalkyl, aryl, haloaryl, alkoxy, aralkyl, sila-cycloalkyl, alkenyl, acrylate, methacrylate, amino, imino, hydroxy, epoxy, ester, alkyloxy, isocyanate, phenolic, polyurethane oligomeric, polyamide oligomeric, polyester oligomeric, polyether oligomeric, polyol, carboxypropyl, or halo.

4. The cured polymer composite of claim 1, wherein the silyl-terminated hybrid polymer comprises an alkoxysilane terminated polyacrylate, polyurethane, epoxy, or polyether.

5. The cured polymer composite of claim 1, wherein the cured polymer composite has one or more of a tensile strength greater than 0.5 MPa or from 0.5 MPa to 10 MPa, an elongation at break of 40% to 300%, and a volume resistivity of less than 10⁵ ohm·cm.

6. (canceled)

7. The cured polymer composite of claim 1, wherein the composition is a cured polymer composition having a shielding efficiency equivalent to at least 35 dB for a 2 mm thick sample at 1.5 GHz.

8. (canceled)

9. The cured polymer composite of claim 1, further comprising at least one additive selected from the group consisting of fumed silica, precipitated silica, semiconducting oxides, nickel coated graphite, metals, metal alloys, carbon fibers, CNTs, graphenes, graphite, carbon black, clay, metal carbides, metal nitrides, metal phosphates, metal sulfates, metal carbonates, metal halides, metal hydroxides, glass, and organic fibers.

10. An article for electromagnetic interference shielding comprising the cured polymer composite of claim 1.

11. A method for preparing a polymer composite for electromagnetic interference shielding, the method comprising:
combining carbon nanostructures with an uncured polymer comprising a curable and moldable polymer selected from a polysiloxane or a silyl-terminated hybrid polymer to form a mixture and disperse the carbon nanostructures in the uncured polymer and generate CNS-derived material selected from fractured carbon nanotubes, elongated CNS strands, dispersed CNS, and any combination thereof;
wherein the carbon nanostructures include a plurality of multiwall carbon nanotubes that are crosslinked in a polymeric structure by being branched, interdigitated, entangled and/or sharing common walls,
wherein the fractured carbon nanotubes are derived from the carbon nanostructures and are branched and share common walls with one another,
wherein elongated CNS strands are derived from the carbon nanostructures and include CNTs that have been displaced linearly with respect to one another, and
wherein the dispersed CNS comprise exfoliated fractured CNTs that do not share common walls with one another.

12. The method of claim 11, wherein combining comprises dispersing the carbon nanostructures until observation of a microscopic image of the mixture having 1000 microns×1400 microns or equivalent area reveals no more than one fragment of a carbon nanostructure having a bundle width greater than 50 microns, wherein the mixture is prepared for observation by diluting the mixture to a CNS-derived material loading of about 0.1% with additional uncured polymer and pressing a drop-sized aliquot between two glass microscope slides.

13. (canceled)

14. (canceled)

15. The method of claim 11, wherein combining comprises mixing the carbon nanostructures with a media selected from an oil, a reactive diluent, a non-reactive diluent, an aqueous solvent, a non-aqueous solvent, or a plasticizer to form a masterbatch, and mixing the masterbatch with the uncured polymer to form the mixture.

16. The method of claim 11, further comprising combining the mixture with a letdown polymer selected from a polysiloxane or silyl-terminated hybrid polymer.

17. (canceled)

18. The method of claim 11, wherein the carbon nanostructures are provided in an amount of 0.01 to 15 wt %.

19. (canceled)

20. (canceled)

21. The method of claim 11, further comprising adding at least one additive to the mixture, the additive selected from the group consisting of fumed silica, precipitated silica, semiconducting oxides, nickel coated graphite, metals, metal alloys, carbon fibers, CNTs, graphenes, graphite, carbon black, clay, metal carbides, metal nitrides, metal phosphates, metal sulfates, metal carbonates, metal halides, metal hydroxides, glass, and organic fibers.

22. The method of claim 11, further comprising curing the mixture or allowing it to cure.

23. The method of claim 11, wherein the mixture is cured in the presence of one or more of a catalyst, heat, cross-linker, moisture, microwave radiation, blue LEDs, ultraviolet light, electron beam radiation, and a photoinitiator.

24. (canceled)

25. (canceled)

26. A curable polymer composition comprising:
an uncured polymer comprising a curable and moldable polymer selected from a polysiloxane or a silyl-terminated hybrid polymer and CNS-derived material selected from fractured carbon nanotubes, elongated CNS strands, dispersed CNS, and any combination thereof;
wherein the carbon nanostructures include a plurality of multiwall carbon nanotubes that are crosslinked in a polymeric structure by being branched, interdigitated, entangled and/or sharing common walls,
wherein the fractured carbon nanotubes are derived from the carbon nanostructures and are branched and share common walls with one another,
wherein elongated CNS strands are derived from the carbon nanostructures and include CNTs that have been displaced linearly with respect to one another, and
wherein the dispersed CNS comprise exfoliated fractured CNTs that do not share common walls with one another.

27. The curable polymer composition of claim 26, wherein when the curable polymer composition is prepared for observation in an optical microscope by diluting the composition to a CNS-derived material loading of about 0.1% with additional uncured polymer and pressing a drop-sized aliquot between two glass microscope slides to create a specimen, a microscopic image showing an area of the specimen of 1000 microns×1400 microns or equivalent area contains no more than one fragment of a carbon nanostructure having a bundle width greater than 50 microns.

28. (canceled)

29. (canceled)

30. The curable polymer composition of claim 26, further comprising an oil, a reactive diluent, a non-reactive diluent, an aqueous solvent, a non-aqueous solvent, or a plasticizer.

31. (canceled)

32. The curable polymer composition of claim 26, wherein the CNS-derived material is present in an amount of 0.01 to 15 wt %.

33. (canceled)

34. (canceled)

35. The curable polymer composition of claim 26, further comprising at least one additive selected from the group of fumed silica, precipitated silica, semiconducting oxides, nickel coated graphite, metals, metal alloys, carbon fibers, CNTs, graphenes, graphite, carbon black, clay, metal carbides, metal nitrides, metal phosphates, metal sulfates, metal carbonates, metal halides, metal hydroxides, glass, and organic fibers.
